(19) United States
(12) Patent Application Publication
(10) Pub. No.: US 2019/0098504 A1
(43) Pub. Date: Mar. 28, 2019

(54) COMPUTER IMPLEMENTED METHOD FOR ASSISTANCE

(71) Applicant: ISN-Partners Ltd., Gloucestershire (GB)

(72) Inventors: ALEXANDER VAN BETSBRUGGE, Stefanova (SK); CEDRIC LEMARECHAL, Silves (BE)

(73) Assignee: ISN-Partners Ltd., Gloucestershire (GB)

(21) Appl. No.: 16/201,589

(22) Filed: Nov. 27, 2018

Related U.S. Application Data
(63) Continuation-in-part of application No. PCT/IB2017/000521, filed on May 6, 2017.
Application No. PCT/IB2017/000521 is a continuation-in-part of application No. PCT/IB2016/000731, filed on May 27, 2016.

(51) Int. Cl. H04W 12/06; H04W 12/04; G06Q 30/06; G06K 7/14; G06K 19/06

(52) U.S. Cl. CPC H04W 12/0608; H04W 12/0401; G06F 9/445; G06K 7/1417; G06K 19/06037; G06Q 30/0633

(57) ABSTRACT

The invention relates to a computer implemented method for assistance for a predetermined asset characterised by asset parameters including at least its type or a sign adapted for characterising at least its type, and advantageously its location or a sign adapted for characterising its location, especially in a building, to an end-user having a mobile communication device with a scanning element or camera, said end-user mobile communication device being adapted to communicate with a computer system for assistance.

### CROSS-REFERENCE TO RELATED APPLICATIONS

The present application is a continuation-in-part application of PCT/IB2017/000521 filed on May 6, 2017 and published on Nov. 30, 2017 under number WO2017/203339 and claiming the benefit of PCT/IB2016/000731 filed on May 27, 2016 (now abandoned), the disclosures of which are hereby incorporated in their entirety by reference.

### BACKGROUND OF THE INVENTION

More and more methods have been proposed in the past for enabling assistance to specific assets.

WO2012/168457 relates to a mobile communication device for facilitating electronic transactions between a first party and a second party, whereby identification code is generated by the user's device via a code generator of the user's device, said code generator generating a code corresponding to the transaction, said code including unique identification data and transaction parameter. The security is thus depending only of the code generator and the security system of the user's device.

US2015/0066782 relates to the use of a central computer suitable for maintaining information about an asset, by receiving signals from a local computer processing signals from sensors of a machine. The central computer can serve for determining servicing and maintenance of an asset, but is not provided for generating authorisation key limiting the access of a specific service provider to a specific area wherein there is a specific asset to service.

WO2008/063936 relates to a method for managing hospital assets, patients and personnel, the method requiring the placement of signal detecting devices, to distribute to each patient or personnel a RFID tag. RFID tag or card can be stolen, whereby the safety cannot be fully guaranteed. Therefore, in hospital, people are using more and more some camera video surveillance.

All said methods have not yet been very conclusive for the end-user, as well as for the service provider. Said methods are therefore not multi-industry, multi type of asset in an easy way for the end-user requiring various assistance in various fields. Such a method is disclosed in U.S. Pat. No. 7,529,680 (said method is adapted for preventing the support staff receiving multiple service requests for a same infrastructure, to spill time for treating all said requests, while preventing said staff to treat other issues and therefore resulting into an inefficient use of the organisation's resources. Said method is not adapted for enabling direct search of the possible service provider), U.S. Pat. No. 8,321,232 (the computer method is intended to prevent support staff to investigate several times a same problem that is affecting the user, which is often related to an infrastructure outage or some sort of planned or unplanned diminished service) and U.S. Pat. No. 7,117,239 (this patent is directed to using a device embedded in an apparatus to report the state of the apparatus to a remote computer. This aspect of the invention features detecting the state of the apparatus, generating a message that reports the state of the apparatus using a self-describing computer language, and sending the message to the remote computer. An example of a self-describing computer language is eXtensible Markup Language (XML). Examples of messages that may be sent include an electronic mail (e-mail) message and a hypertext transfer protocol (HTTP) command, both containing XML code.).

All said known methods are not sufficiently secure assets and confidential information, when a service provider is entering into a building for operating assistance to an asset, in view among other of a lack of automatic control mechanism advising one or more employees of the presence of said external service provider in the building, as well as the path he has to follow for reaching the asset requiring the assistance, and moreover for preventing automatically the service provider to have access to the room after the assistance operation on the asset and outside the date and hour range foreseen for the assistance working.

### SUMMARY OF THE INVENTION

The present invention in its preferred embodiment relates to a computer implemented method for assistance for an asset enabling secure assistance operation and/or secure entry of a person into a protected area, so as to prevent proprietary information (like images and sounds) or documents to be stolen during an operation by a service provider to an asset or a person entering into a protected area.

The invention relates in its preferred embodiment to a computer implemented method for assistance for a predetermined asset characterised by asset parameters including at least one scannable asset characterising parameter selected among the group consisting of asset type parameter, sign adapted for characterising at least the asset type and the asset location on a site or in a building, tag adapted for characterising at least the asset type and the asset location on a site or in a building, to at least a first end-user selected among a group of end-users having each a mobile communication device provided with a scanning element (such as a camera, camera sensor, optical reading system, RFID reading system), whereby the said scannable asset characterising parameter is attached to the said predetermined asset, said at least first end-user mobile communication device being adapted to communicate with a computer system for assistance. The communication can be done through a phone operating system, via the web, via specific communication applications, etc.

The preferred method of the invention comprises at least the following steps:
loading a communication control application on the mobile communication device of the said at least first end-user for secure communicating with the computer system for assistance after an authentication process with the computer system for assistance, said authentication process being operated at least partly within the mobile communication device of the said at least first end-user (the loaded application is advantageously specific for a group of end-users or for controlling accesses to a building, etc. The loaded control communication application is also preferably adapted for specifically communicate with the computer system for assistance. The application can also be automatically updated. The computer system for assistance can comprises a plurality of computers, servers, etc. connected there between);
defining, for each of a group of several end-users, at least one key selected from the group consisting of security key code, password enabling communication between the mobile communication device of an end-user of said group and the computer system for assistance for the said predetermined asset, password authorising communication between the mobile communication device of an end-user of said group and the computer system for assistance for the said predetermined asset, and password limiting communication between the mobile communication device of an end-user of said group and the computer system for assistance for the said predetermined asset (the key of an end-user is advantageously a combination of at least a key portion generated by the end-user and a key portion generated by the computer system for assistance), whereby defining a plurality of different keys;
storing the said different keys in a keys containing database in communication with the computer system for assistance for identifying an end-user of said group, the said different keys being sent to the computer system for assistance which comprises instruction for storing the said different keys into the said keys containing database, so as to enable at least the computer system for assistance to implement a recognition function selected from the group consisting of a function to recognise a predetermined end-user using the communication control application, and a function for defining an authentication password to be sent to a predetermined end user by using the communication control application by a message;
opening by said predetermined end-user of the communication control application on the mobile communication device of the predetermined end-user, and recognising the predetermined end-user by the computer system for assistance by the key corresponding to the said predetermined end-user for enabling communication between the mobile communication device of the predetermined end-user and the computer system for assistance;
scanning a scannable characterising parameter (such as a QR code or another tag, like a RFID, etc.) attached to a predetermined asset through the scanning element of the mobile communication device of the said predetermined end-user,
transmitting by the said predetermined end-user's mobile communication device, the scanned scannable characterising parameter attached to the predetermined asset, to the computer system for assistance;
computing by the computer system for assistance of the scanned scannable characterising parameter attached to the predetermined asset for registering the said predetermined asset, at least by storing the scanned scannable characterising parameter, as well as a plurality of asset working parameters of the predetermined asset, in an asset database in communication with the computer system for assistance (the database can also advantageously comprise links or web addresses for searching on the web characteristics and parameters of one or more assets);
opening of an assistance function of the communication control application by a predetermined end-user mobile communication device, after a logs in requiring encoding the key corresponding to the predetermined end user;
checking by the communication control application of the predetermined end-user mobile communication device, whether the predetermined end-user mobile communication device is authorised to communicate with the computer system for sending an assistance request following the scanning of a scannable characterising parameter attached to an asset, (for example an asset assistance request can only be sent to the computer system for assistance after checking payment of the necessary annual or periodic fee, account sufficient for providing the requested assistance; the APP of the end-user mobile communication can also advantageously be provided with a memory status with an=access data provided from the computer system for assistance, said access data varying advantageously between a first access data enabling transfer of a request for assistance, and a second access date preventing transfer of a request for assistance, but enabling communication with the computer system for assistance for renewing a subscription or for funding an end-user account for assistance works);
   whereby in case of authorisation of communication of the end-user mobile communication device with the computer system for assistance for the said predetermined asset, transferring the scannable characterising parameter and information about an assistance request for an assistance required for the said predetermined asset, by the end-user mobile communication device to the computer system for assistance;
computing by the computer system for assistance an assistance control step for controlling at least whether the predetermined end-user key is authorising the said computer system for treating an assistance request from the said predetermined end-user mobile communication device, and whether an assistance request for said predetermined asset corresponding to the transferred scannable characterising parameter is already treated by the computer system for assistance,
sending, following the said assistance control step, by the computer system for assistance to the predetermined end user's mobile communication device at least one message selected from the group consisting of: a message advising that the predetermined end-user is not entitled to file a request for assistance for the said predetermined asset, a message confirming the prosecution of the request of assistance for said predetermined asset sent by the said end-user, and a message signalling that a request of assistance for the said predetermined asset is already handled by the computer system for assistance, and
selecting by the computer system for assistance, at least one service provider selected from a database in communication with the computer system for assistance for managing the assistance request of the predetermined asset, and contacting the said at one selected service provider through his mobile communication device so as to provide him at least information about the predetermined asset requiring assistance, information about the requested assistance for said predetermined asset, and information about the location of the said predetermined asset in a building;
receiving from the mobile communication device of the selected service provider and from a mobile communication device of an asset dedicated person selected from the group consisting of the end-user and a person dedicated to manage the said predetermined asset in the building, a series of dates and hours convenient for assistance working to the said predetermined asset, and selecting in said series of dates and hours at least one date and hour for the assistance working convenient for both the selected service provider and the asset dedicated person, and confirming by the computer system for assistance, to said selected service provider and said asset dedicated person, the date and hours for the assistance work, as well as information associated to a path to follow by the selected service provider for reaching the predetermined asset in the building (the information associated to the path to follow can comprise a key or a password, which will be converted into a map, advantageously just before the entrance of the service provider in the building, for example at most 15 minutes before the start of the agreed date and hour range for the assistance working),
controlling by the computer system for assistance information about displacement of the selected service provider in the building, said computer system for assistance receiving at least the following information: information from the mobile communication device of the selected service provider relating to the date and hour when the selected service provider enters into the building or part thereof where the predetermined asset requiring assistance is located, information from the mobile communication device of the asset dedicated person confirming the asset dedicated person is present into the building or part thereof where the predetermined asset requiring assistance is located, information about the path followed by the selected service provider in the building, information about the assistance working carried out by the selected service provider, information relating to the end of the assistance working by the mobile communication device of the selected service provider, and information from the mobile communication device of the asset dedicated person confirming the end of the assistance working by the selected service provider;
editing automatically by the computer assistance system a report on the carried assistance working, said report comprising at least information about the selected service provider and information about the completion of the assistance working, and
sending automatically the said report or part thereof, by the computer system for assistance, at least to the mobile communication device of the asset dedicated person.

The method of the invention enables that an automatic exchange of information between the computer system for assistance and the end-user, as well as with the assistance provider, while limiting the direct contact between the end-user and the service provider before the assistance working. The method accepts thus only communication from a pre registered mobile communication device, which is well characterised by one or more parameters, whereby accepting only request for an assistance work from selected end-users and whereby transferring information about the requested assistance work to selected service provider. The method of the invention determines automatically whether an assistance request for an asset is already registered in the system, whereby preventing that more than one service provider is sent to the building for assistance works to an asset.

According to a preferred embodiment of the method of the invention, the step of registering the asset further comprises the transmission of a serial number of the asset, while, before registering the asset, the computer system for assistance controls whether the predetermined end-user mobile communication device is authorised to communicate with the computer system for assistance for the step of registering the asset, and in the affirmative, whether an asset having the said serial number has already been registered, whereby in case the predetermined end-user mobile communication device is not authorised to register said asset, the computer system for assistance sends an error message to a mobile communication device of at least a person selected from the group consisting of the end-user and the asset dedicated person, while in case the asset is already registered in the asset database, the computer system for assistance sends an error message at least to the end-user's mobile communication device.

Another preferred method of the invention, which can comprise one or more of the steps of the method disclosed here above is:

a computer implemented method with a computer system controlling assistance work to a predetermined asset characterised by asset parameters including at least one scannable asset characterising parameter comprising at least the asset location in a protected area of a building protected by a control entrance device associated to a scannable entrance characterising parameter,

wherein the assistance of the predetermined asset has to be carried out by an assistance provider having a mobile communication device with at least one scanning element, said mobile communication device having a communication control application for communicating with the computer system, said method comprising at least the following steps:

sending by the computer system for assistance the timing of a request of assistance work to the mobile communication device of the assistance provider;

confirming by the mobile communication device of the assistance provider, reception of the timing of the request of assistance work;

sending by the computer system to the mobile communication device of the assistance provider, a first In-Map information comprising map information of the building up to the control entrance device of the protected area, said first In-Map information not comprising precise information about location of the predetermined asset in said protected area;

at most 15 minutes before the timing of the request of assistance work, sending by the computer system to the mobile communication device of the assistance provider, an entrance key;

scanning the scannable entrance characterising parameter by the at least one scanning element of the mobile communication device of the assistance provider;

sending the scannable entrance characterizing parameter and the entrance key by the mobile communication device of the assistance provider to the computer system;

controlling a matching of the timing of the request of assistance, the scannable entrance characterising parameter and the entrance key, by the computer system, whereby the computer system implements (a) at least one first entrance control instruction selected among the group consisting of opening instruction for the control entrance device adapted for enabling the opening of the control entrance device in case of matching of the timing of the request of assistance, the scannable entrance characterising parameter and the entrance key, and a warning instruction blocking the control entrance device in case of lack of matching of the timing of the request of assistance, the scannable entrance characterising parameter and the entrance key, and (b) an In-Map information enabling precise location of the predetermined asset in said protected area, in case of matching of the timing of the request of assistance, the scannable entrance characterising parameter and the entrance key;

sending to the control entrance device at least said one entrance control instruction for enabling the assistance provider to enter into the protected area in case of matching of the timing of the request of assistance, the scannable entrance characterising parameter and the entrance key, while preventing the assistance provider to enter in the protected area in case of lack of matching of the timing of the request of assistance, the scannable entrance characterising parameter and the entrance key;

sending to the mobile communication device of the assistance provider of the In-Map information enabling precise location of the predetermined asset in said protected area, in case of matching of the timing of the request of assistance, the scannable entrance characterising parameter and the entrance key;

scanning the scannable asset characterising parameter of the predetermined asset by the at least one scanning element of the mobile communication device of the assistance provider;

sending the scannable asset characterising parameter of the predetermined asset by mobile communication device of the assistance provider to the computer system; and

computing by the computer system of a precautionary instruction selected among the group consisting of a blocking instruction for the control entrance device after receipt of the scannable asset parameter by the computer system from the mobile communication device of the assistance provider, a blocking instruction for the control entrance device after the timing of the request of assistance work, an instruction for deleting on the mobile communication device of the service provider the In-Map information enabling precise location of the predetermined asset in said protected area after receipt of the scannable asset parameter by the computer system from the mobile communication device of the assistance provider, an instruction for deleting on the mobile communication device of the service provider the In-Map information enabling precise location of the predetermined asset in said protected area after the timing of the request of assistance work, and combinations thereof.

Advantageous details of embodiments of the computer implemented methods of the invention are one or more of the followings:
the computer system for assistance is supplying to the mobile communication device of the selected service provider and to the mobile communication device of the asset dedicated person an In-map description of the path to follow in the building for reaching the asset requiring assistance.
The computer implemented method comprises the following further steps:
defining step by the asset dedicated person for defining and communicating through his mobile communication device to the computer system for assistance, the path to follow by the service provider to reach the predetermined asset requiring assistance, and
a remainder step whereby the computer system for assistance sends at least to the mobile communication device of the asset dedicated person and to the mobile communication device of the service provider a reminder message reconfirming the date and hour range for the assistance service.
   the service provider has a mobile communication device with scanning function, whereby the method comprises the following further steps:
scanning by the mobile communication device of the selected service provider, the scannable asset characterising parameter of the asset requiring assistance, and sending said scannable asset characterising parameter, by said mobile communication device of the selected service provider to the computer system for assistance, before starting assistance working on the asset by the service provider,
following the receipt of said scannable asset characterising parameter from the mobile communication device of the selected provider by the computer system for assistance, automatic checking by the computer system for assistance, at least one of the points selected form the group consisting of: (a) whether the scanned scannable asset characterising parameter fits to the asset requiring assistance by the said selected service provider; (b) whether the scanned scannable asset characterizing parameter fits to an asset no more requiring assistance by the said selected service provider; and (c) whether the scanned scannable asset characterising parameter fits to an asset requiring assistance at a selected time range not fitting with the date and hour previously dedicated for the assistance work;
following said automatic checking, emitting automatically by the computer system for assistance, to at least to both the mobile communication device of the selected service provider and to the mobile communication device of the asset dedicated person, a message selected from the group consisting of (a) a message confirming that the scanned scannable asset characterising parameter corresponds to the parameter of the asset requiring assistance, (b) a warning message that the scanned scannable asset characterising parameter does not fit with the asset requiring assistance, (c) a warning message that the scanned scannable parameter asset corresponds to an asset not requiring assistance at the selected time range.

This step is very useful, as enabling a direct control by the computer system for assistance about the asset on which the service provider will carry assistance works.
The computer implemented method further comprises the steps of:
defining, after a registration step of an asset, an asset characterising parameter by the computer system for assistance for the asset to be registered;
communicating the said asset characterising parameter by the computer system for assistance, to the asset dedicated person, while requiring him to print it on a support for forming a printed asset characterising parameter;
printing the asset characterising parameter on the support, and
attaching the support with the printed asset characterising parameter by the asset dedicated person.
   the end-user has a series of end-user independent mobile communication devices provided each with a scanning element, which are each adapted for
scanning the scannable asset characterising parameter attached to a predetermined asset; and
transferring the scanned scannable asset characterising parameter of the predetermined asset, as well as information about an assistance request for an assistance required for the said asset, to the computer system for assistance;

in which the computer implemented method has the further steps:
automatic controlling by the computer system for assistance when receiving at least from one of the series of the end-user independent mobile communication devices a scannable asset characterising parameter attached to the predetermined asset, whether an assistance request for the said predetermined asset has already been transmitted to the computer system for assistance, and
transmitting automatically by the computer system for assistance to at least several end-user independent mobile communication devices of the said series, a message comprising the date and hour range for the assistance service, as well as information about the service provider for said assistance service.
   the asset requiring assistance is located in a protected area of the building, said protected area being protected by a special authorisation key authorising the access to the said protected area, said method further comprising at least the step of:
Sending by the computer system for assistance to the mobile communication device of the selected service provider the special authorization key authorizing the service provider to enter the said protected area for a date and a hour range for the assistance service, at most 15 minutes before the start of the dedicated date and hour range for the assistance service to be carried out by the said selected service provider.

The computer system for assistance is acting as an external security provider for preventing the service provider to enter in a building, outside the appropriate date and time range.
in case the computer system for assistance receives from a mobile communication device of an asset dedicated person, a scannable asset characterising parameter of a first asset requiring assistance, the computer system for assistance checks whether a service provider suitable for assistance to the said first asset for which assistance is required has already been requested for assistance of another asset within the building, and sends to the mobile communication device of said service provider for assistance of said other asset, at least a message requiring to also carry assistance work for the said first asset at a same date.

This enables to an accepted service provider already in the building to carry out assistance works at another asset within the building.
The computer implemented method implemented for at least one asset associated to at least one consumable good, whereby the access by a predetermined end-user to said one asset associated to said at least one consumable good is protected by a control access system, in which the method comprises the following steps:
checking by the computer system for assistance, whether the key attached to the communication control application of the end-user mobile communication device of said predetermined end-user authorises or not the said predetermined end-user to have access to said at least one consumable good associated to said asset in consideration,
after checking that the end-user's key authorises the access to said at least one consumable good from the predetermined asset, opening of a menu of the communication control application of the end-user's mobile communication device, said menu providing information about the said at least one consumable good available at the predetermined asset;
encoding by the end-user on his mobile communication device of at least one consumable good parameter selected among the group consisting of type of consumable good intended to be consumed, number of consumable good intended to be consumed, and combination thereof;
sending by the end-user mobile communication device to said computer system for assistance, at least the said at least one consumable good parameter;
sending by the computer system for assistance access information to the predetermined asset, authorising the end-user to have access to said at least one consumable good at the predetermined asset in accordance to the said at least one consumable good parameter;
computing by the computer system for assistance at least the type and number of consumable goods used by end-users for each assets with consumable goods, whereby determining automatically in function of a stock of consumable goods still available for said at least one predetermined asset,
   a) whether said consumable goods have to be ordered to at least one supplier, whereby automatically ordering from said at least one supplier to supply the necessary consumable goods;
   b) whether said at least one predetermined asset has to be refilled with consumable goods, whereby sending automatically a refillable message to the mobile communication device of the asset dedicated person.
the computer implemented method for at least one asset with consumable goods located within a room provided with a control entrance device provided with a control system in communication with the computer system for assistance and with a scannable entrance parameter, whereby the access by an end-user to said room is protected by the control access system, which, after checking the authorisation key of the end-user mobile communication device, controls the access of the end-user to said room, said method comprising the following steps:
scanning the scannable entrance parameter associated to the control entrance device by the end-user mobile communication device, and sending said scannable entrance parameter by the end-user mobile communication device to the computer system for assistance;
checking in a checking step by the computer system for assistance whether the end-user mobile communication device is listed in an identification database comprising identification parameter of a series of end-user mobile communication devices with authorisation key;
in case the said checking step confirms that the end-user mobile communication device has his identification parameter into the identification database, requiring from the end-user to encode his authorisation key and to send said authorisation key by the end-user mobile communication device to the computer system for assistance;
checking the authorisation key received from the end-user mobile communication device by the computer system for assistance, so as to determine whether said received authorisation key is associated to an authorisation to enter the room;
in case the checking step confirms that the received authorisation key from the end-user mobile communication device is associated to an authorisation to enter the room, sending by the computer system for assistance of an instruction to the control system controlling the control entrance device for enabling the end-user to enter in the room, and opening of a menu of the communication control application of the end-user mobile communication device, said menu providing information selected from the group consisting of at least (a) information about the at least one asset available in the room, (b) information about consumable goods available at the at least one predetermined asset, and (c) combination thereof;
encoding by the end-user on his mobile communication device of at least the number and type of the at least one consumable good the end-user intends to consume;
sending by the end-user mobile communication device to said central system for assistance, at least the number and type of consumable goods intended to be consumed by the end-user;
sending by the computer system for assistance access information to the predetermined asset or to an asset control system, for limiting the end-user to have access to the type and numbers of the at least one consumable good intended to be consumed by the end-user at the predetermined asset.
   The computer implemented method implemented for a series of rooms with a series of assets associated to consumable goods, and for a series of end-users, said method further comprising the following further steps:
computing by the computer system for assistance information about the use of the rooms, the use of the assets, as well as of the type and number of consumable goods consumed by the end-users, whereby determining automatically in function of the use of at least of one of said rooms, as well as in function of a stock of consumable goods still available,
   a) whether the at least one of said rooms requires a cleaning, whereby sending a message to a mobile communication device of a cleaning assistant for operating an appropriate cleaning of the at least one of said rooms;
   b) whether at least one of said consumable goods has to be ordered to at least one supplier, whereby automatically ordering from said at least one supplier to supply the ordered at least one of said consumable goods;
   c) whether at least one of the said assets has to be submitted to an operation selected from the group consisting of refilling, cleaning or maintaining by an appropriate assistant, whereby sending to a mobile communication device of said appropriate assistant, a message requiring the said operation to be carried for the said at least one of said assets; and
   d) when the number of the at least one of said consumable goods used at least one of said assets exceeds a predetermined level, sending a control signal to said one or more assets or to the asset control system for blocking further access to said consumable goods and/or to said at least one of said assets.

Advantageously, the menu of the communication control application of the end-user mobile communication device further requests from the end-user to send a message to the computer system for assistance in at least one case selected among the group consisting of: (a) in case of a problem at the asset, (b) in case of a problem with consumable goods, (c) in case of problem with the room, and (d) in case of lack of problem;

whereby, after receiving a message relating to the presence of a problem, enabling the computer system for assistance to automatically send a message on the mobile communication device of an appropriate assistant requesting to correct the problem listed in the message sent by the computer system for assistance, and requesting to send to the computer system for assistance a report relating to said problem.
The computer implemented method for at least one asset with consumable goods located within a room provided with a control entrance device provided with a control system in communication with the computer system for assistance and with a scannable entrance parameter, whereby the access by an end-user to said room is protected by the control access system, which, after checking the authorisation key of the end-user mobile communication device, controls the access of the end-user to said room, said method comprising the following steps:
scanning the scannable entrance parameter associated to the control entrance device by the end-user mobile communication device, and sending said scannable entrance parameter by the end-user mobile communication device to the computer system for assistance;
checking in a checking step by the computer system for assistance whether the end-user mobile communication device is listed in an identification database comprising identification parameter of a series of end-user mobile communication devices with authorisation key;
in case the said checking step confirms that the end-user mobile communication device has his identification parameter into the identification database, requiring from the end-user to encode his authorisation key and to send said authorisation key by the end-user mobile communication device to the computer system for assistance;
checking the authorisation key received from the end-user mobile communication device by the computer system for assistance, so as to determine whether said received authorisation key is associated to an authorisation to enter the room;
in case the checking step confirms that the received authorisation key from the end-user mobile communication device is associated to an authorisation to enter the room, sending by the computer system for assistance of an instruction to the control system controlling the control entrance device for enabling the end-user to enter in the room, and opening of a menu of the communication control application of the end-user mobile communication device, said menu providing information selected from the group consisting of at least (a) information about the at least one asset available in the room, (b) information about consumable goods available at the at least one predetermined asset, and (c) combination thereof;
encoding by the end-user on his mobile communication device of at least the number and type of the at least one consumable good the end-user intends to consume;
sending by the end-user mobile communication device to said central system for assistance, at least the number and type of consumable goods intended to be consumed by the end-user;
sending by the computer system for assistance access information to the predetermined asset or to an asset control system, for limiting the end-user to have access to the type and numbers of the at least one consumable good intended to be consumed by the end-user at the predetermined asset;
in which, after sending by the computer system for assistance an instruction to the control system controlling the control entrance device to the room, the communication control application of the end-user mobile communication device opens a menu listing a series of assets assumed to be present within the said room, said menu requiring from the end-user to confirm by sending by at least one signal to the computer system for assistance relating to said series of assets, said at least one signal being selected at least from the group consisting of (a) signal reporting the presence of the assets of said series, (b) signal reporting the lack of at least one asset of said series, (c) signal reporting damage of at least one asset of said series, (d) pictures of at least a part of the room, and (e) combinations thereof,
in which after receiving said at least one signal from the end-user mobile communication device, the computer system for assistance computes automatically whether at least one asset intended to be present in the room is signalled with a warning signal selected among the group consisting of a warning signal reporting the lack of at least one asset of said series, a warning signal reporting damage of at least one asset of said series, and a combination thereof, the computer system for assistance sends automatically a message on the mobile communication device of at least one assistant requiring at least an inspection report about the at least one warning signal.
   The computer method in which the appropriate assistant mobile communication device is loaded with a communication application for communicating with the computer system for assistance, said mobile communication device having at least a scanning element and being at least characterised by one characterising parameter,

whereby a security key is attributed to the assistant, said security key being associated to at least one characterising parameter of the assistant's mobile communication device, whereby an assistants' database is built up for containing characterising parameter of mobile communication devices of a series of assistant, and the security key allocated to each of said series of assistants,

whereby the access to the room is protected by the control system of the control entrance device,

said method comprising at least the following steps:
scanning the scannable entrance parameter associated to the control entrance device by the assistant's mobile communication device, and sending said scannable entrance parameter to the computer system for assistance;
checking in a checking step by the computer system for assistance whether the assistant's mobile communication device has its characterising parameter listed in the assistants' database;
in case the said checking step confirms that the assistant's mobile communication device has its characterising parameter into the assistants' database, requiring from the assistant to encode his security key and to send it to the computer system for assistance;
checking the security key received from the assistant mobile communication device, so as to determine whether said received security key is associated to an authorisation to enter the room;
in case the checking confirms that the received security key is associated to an authorisation to enter the room, sending by the computer system for assistance an instruction to the control system controlling the control entrance device for enabling the assistant to enter in the room, and opening of a menu of the communication control application providing information selected from the group at least consisting of information about the at least one asset available in the room, information about consumable goods available at the at least one predetermined asset, and operation information relating to operation to be carried out by the assistant in the room;
encoding by the assistant at least operation information selected from the group consisting of cleaning works, refilling consumable goods in at least one asset, repairing operation, maintenance operation, replacement operation of at least one asset, installation of a new asset in the room, and removal of at least one asset from the room;
advantageously, when the assistant goes away from the room, scanning the entrance parameter (such as a QR-code or tag attached or associated to the door or gate or control system) by the scanning function of the assistant mobile communication device, whereby the computer system for assistance preferably inactivates the authorisation for said assistant to re enter into the room, without further authorisation or further checking operation as disclosed here before;
automatic computing by the computer system for assistance, whether the at least one operation to be operated in the room matches with signals received from the assistant mobile communication device, whereby determining at least the one operation to be carried out by the assistant not matching with the received assistants' signals, whereby the computer system for assistance automatically sends a message selected from the group consisting of warning message and remainder message to mobile communication device selected from the group consisting of assistants mobile communication devices for the at least one operation still to be carried out;
advantageously automatic check whether the scanned parameters of the assets (such as tags or QR-codes of the assets) for one or more rooms match with the assets assumed to be present in the one or more rooms or with the assets as checked previously by one or more assistant mobile telecommunication devices and/or by one or more end-user mobile telecommunication devices, whereby the computer system determines whether one or more assets has/have disappeared from one room or has been displaced from one room to another, whereby the computer system for assistance sends automatically to a controller mobile communication device a signal for checking/controlling the assets present in one or more rooms. The controller can be a manager or the person dedicated to the one or more assets present in the building.
   combinations of such details/characteristics.

The method of the invention is thus a method which wants to be simple of use for the end-user, as well as for the service provider, while ensuring a safe control of the access rights of the service provider, as well as advantageously a guaranteed servicing of the asset to be maintained or serviced. It enables, in specific embodiments, to determine quickly whether a room or asset is available to end-users, as well as to determine the not normal use of one or more consumable goods, as well as to determine a time period when one or more assets have disappeared form one or more rooms, and advantageously to establish a path to be followed by an assistant, so the rooms and assets are cleaned/maintained in the best order so as to reduce the time of unavailability of assets in view of use time of the rooms by end-users. The method of the invention in preferred embodiment is also a method for determining quickly whether some assets have been theft, whereby enabling quickly manager or controller to investigate the situation. As the consumable goods are reported in some embodiments, it enables to avoid random supply. In case of replacement of one or more assets in a room, embodiments of the application enables to end-user to scan the QR-code or tag of the new machine, whereby enabling the reporting of the consumables used with respect to said new machine or asset.

Advantageously, in the method of the invention, given the recognition of the asset because of serial # or other means, these assets can be categorised, but also the users, the service providers and asset dedicated persons can be categorised.

Asset categorising: Depending on the type of asset, the pop-up menu on the system (App) will show the correct menu with the choice of the correct messages to use. (in other words, there is no request for coffee on a printer, but the printer menu can ask for a toner, a repair for a printer etc.

User categorising: Depending on the type of user in an organisation or function of the user in the organization, automatically the correct part of the data can show up.

Example of user categorising:
The supplier of the fire extinguisher receives the serial number, contract type and sales date.
The technician sees expiry date and service history
The end user sees asset nbr, picture, manual and next service date interval.
Etc.

The invention relates also to a method (i.e. a computed method or a computer implemented method) for securing the access of a person or a group of persons in an area (such as a room, building, stadium, concerts, air planes, etc.).

Allowing or denying access to people is more and more complicated, as some time guards are not able to request passports or identity cards from the people wanting to have access to a protected area, such as a concert field. In some countries, no identity cards exist at all. Moreover, all said checks is time consuming with many possible errors.

For entering buildings or a protected area or site (such as an industrial production site), the person has first to log in a visiting book, before receiving a pass for opening a gate. Many people omit to give back the pass, whereby rendering complicate to know whether a person walking in a building is authorised or not.

Embodiments of methods according to the invention aims to solve also said problem with a method enabling quick check whether a person can enter into a protected area.

A first embodiment of the method of the invention or the computer implemented method of the invention is a method for securing the access of at least a person a protected area associated to an access control system, whereby the said person is provided with a mobile communication device with a wireless application enabling at least the mobile communication device to communicate with a control access server via a wireless system (phone communication system, WIFI, bluetooth, web, etc.), said mobile communication device (like a mobile phone, an iPad, etc.) being provided with a screen suitable for viewing at least a QR Code, while the access control system is associated at least to a scanning device (the scanning device can be part of a device used by a guard, or can be an automatic gate provided with a scanning system and which can be opened if the check is confirming the access authorisation) suitable for scanning at least a QR-code, as well as to a communication system for communicating with the control access server,

Whereby the said method comprises at least the following steps:

downloading step on the mobile communication device of the said person of a control access application, said downloading step requiring at least one registration step with the control access server, whereby the mobile communication device of the said person is provided with a registered control access application associated to at least a secret mobile communication device identifying code which is secret for the said person, but which is readable by the control access server through a wireless system, sending to the access control system by the said person via the registered control access application of the mobile communication device through the wireless system, an access request to the protected area within a determined time period of access;

receiving the access request to the protected area within said determined time period of access, as well as the said secret mobile communication device identifying code or a parameter function of the said secret mobile communication device identifying code, by the control access server;

authentication the said secret mobile communication device identifying code or parameter function of the said secret mobile communication device identifying code by said control access server, so that the said control access server determines in a request validation step whether for the authenticated secret mobile communication device identifying code, the access request to the protected area within said predetermined time period of access is a validated access request for the authenticated secret mobile communication device identifying code;

after confirmation by the request validation step that the access request to the protected area within said predetermined time period is a validated access request for the authenticated secret mobile communication device identifying code, generating an access QR code by the control access server, said access QR code comprising at least (a) a first coding element enabling to identify the said person or the mobile communication device of the said person, and (b) a second coding element enabling to identify a validity time period for the QR Code;

transferring the said access QR code, by the control access server to the mobile communication device of the said person, via said wireless system;

receiving and memorising the said access QR code by the said mobile communication device;

before that the said person tries to have access to the protected area, loading the said access QR code or an amended access QR code generated by the control access application on the screen of the mobile communication device of the said person, said loaded access QR code or loaded amended access QR code comprising at least (a) the first coding element enabling to identify the said person or the mobile communication device of the said person, and (b) a second coding element enabling to identify a validity time period for the loaded access QR Code or amended access QR code;

scanning the access QR code or amended access QR code loaded on the screen of the mobile communication device of the said person by the scanning device associated to the access control system, whereby generating a scanned access QR code comprising at least the first coding element and the second coding element;

transferring the scanned access QR code by the access control system to the control access server;

reading the scanned QR code by the control access server so as to read the at least first coding element and second coding element;

checking by the control access server whether at least (a) said first coding element or a coding parameter at least function of the first coding element and (b) said second coding element are matching to a valid access authorisation to the protected area for the said person at a checking time comprised within a time period starting at most 30 minutes before the said determined time period of access and ending at most at the end of the determined time period of access;

In case of no matching to a valid access authorisation, emitting and transferring a non access signal by the control access server to the access control system, the latter when receiving the said non access signal denying access authorisation for the said person to the protected area, while in case of matching to a valid access authorisation, emitting and transferring an access signal by the control access server to the control access system, whereby authorising the said person to have access to the protected area.

Advantageously, the step of generating an access QR code by the control access server is adapted for generating a QR code comprising at least a first coding element enabling to identify the said person or the mobile communication device of the said person, a second coding element enabling to identify a validity time period for the QR Code, as well as a third coding element resulting from an algorithm operation, while in case of matching of the first coding element and the second coding element the checking step by the control access server computes from the said first coding element and second coding element a computed third coding element and determines whether the computed third coding element matches with the third coding element of the scanned QR code, whereby in case of no matching, the control access server emits and transfers to the access control system a non access signal, while in case of matching, an access signal is transmitted to the control access system.

Preferably, in case of emitting and transferring an access signal by the control access server to the control access system, the control access server attaches to a coding element selected from the group consisting of the first coding element and the second coding element of the mobile communication device an instruction for non access. Moreover, preferably, the control access server sends to the mobile communication device in-map information, advantageously temporary in-map information, about the path to follow by the person in the protected area (for example for finding his way to the seat allotted to him, the facility, etc.

Most preferably, the said instruction for non access is transferred by the central access server to the mobile communication device.

In a specific embodiment, the said instruction for non access is transferred by the central access server to the mobile communication device, said instruction comprising a temporary instruction limiting the use of at least one function selected among the group consisting of camera and recorder during the determined time period of access.

According to a further embodiment, the method of the invention is a method for securing the access of a person in an area through a protected area associated to an access control system, whereby the said person is provided with a mobile communication device with a wireless application enabling at least the mobile communication device to communicate with a control access server via a wireless system, said mobile communication device being provided with a screen suitable for viewing at least a QR Code, while the access control system is associated at least to a scanning device suitable for scanning at least a QR-code, as well as to a communication system for communicating with the control access server,

Whereby the said method comprises at least the following steps:

downloading step on the mobile communication device of the said person of a control access application, said downloading step requiring at least one registration step with the control access server, whereby the mobile communication device of the said person is provided with a registered control access application associated to at least a secret mobile communication device identifying code which is secret for the said person, but which is readable by the control access server through a wireless system,

sending to the access control system by the said person via the registered control access application of the mobile communication device through the wireless system, an access request to the protected area within a determined time period of access;

receiving the access request to the protected area within said determined time period of access, as well as the said secret mobile communication device identifying code or a parameter function of the said secret mobile communication device identifying code, by the control access server;

authentication the said secret mobile communication device identifying code or parameter function of the said secret mobile communication device identifying code by said control access server, so that the said control access server determines in a request validation step whether for the authenticated secret mobile communication device identifying code, the access request to the protected area within said predetermined time period of access is a validated access request for the authenticated secret mobile communication device identifying code;

after confirmation by the request validation step that the access request to the protected area within said predetermined time period is a validated access request for the authenticated secret mobile communication device identifying code, generating an access QR code by the control access server, said access QR code comprising at least (a) a first coding element enabling to identify the said person or the mobile communication device of the said person, (b) a second coding element enabling to identify a validity time period for the QR Code and (c) a third coding element resulting from an algorithm operation at least based on a parameter function of the secret mobile communication device identifying code and on a parameter function of the validity time period;

transferring the said access QR code, by the control access server to the mobile communication device of the said person, via said wireless system;

receiving and memorising the said access QR code by the said mobile communication device;

before that the said person tries to have access to the protected area, loading the said access QR code or an amended access QR code generated by the control access application on the screen of the mobile communication device of the said person, said loaded access QR code or loaded amended access QR code comprising at least (a) the first coding element enabling to identify the said person or the mobile communication device of the said person, (b) a second coding element enabling to identify a validity time period for the loaded access QR Code or amended access QR code and (c) a third coding element generated from an algorithm operation at least based on a parameter function of the secret mobile communication device identifying code and on a parameter function of the validity time period;

scanning the access QR code or amended access QR code loaded on the screen of the mobile communication device of the said person by the scanning device associated to the access control system, whereby generating a scanned access QR code comprising at least the first coding element, the second coding element and the third coding element;

transferring the scanned access QR code by the access control system to the control access server;

reading the scanned QR code by the control access server so as to read the at least first coding element, second coding element and third coding element;

computing by the control access server a computed third coding element from at least the first coding element or parameter thereof and the second coding element or parameter thereof;

checking by the control access server whether said computed third coding element or a parameter thereof having to match with the third coding element of the scanned QR code or parameter thereof, as well as whether at least (a) said first coding element or a coding parameter at least function of the first coding element, (b) said second coding element or a parameter function of the second coding element are matching to a valid access authorisation to the protected area for the said person at a checking time comprised within a time period starting at most 30 minutes before the said determined time period of access and ending at most at the end of the determined time period of access;

whereby the control access server transfers to the access control system a non access signal for the said person at least for a non matching case selected from the group consisting of the not matching case of the computed third coding element or parameter thereof with the third coding element of the scanned QR code or parameter thereof and the not matching case of (a) said first coding element or a coding parameter at least function of the first coding element and (b) said second coding element or a parameter function of the second coding element with the said valid access authorisation, while the control access server transfers to the access control system a valid access authorisation signal in case of the matching of the computed third coding element or parameter thereof with the third coding element of the scanned QR code or parameter thereof and the matching of (a) said first coding element or a coding parameter at least function of the first coding element and (b) said second coding element or a parameter function of the second coding element with the said valid access authorisation.

Advantageously, the step of generating an access QR code by the control access server is adapted for generating a QR code comprising at least a first coding element enabling to identify the said person or the mobile communication device of the said person, a second coding element enabling to identify a validity time period for the QR Code, as well as a third coding element resulting from an algorithm operation, while in case of matching of the first coding element and the second coding element the checking step by the control access server computes from the said first coding element and second coding element a computed third coding element and determines whether the computed third coding element matches with the third coding element of the scanned QR code, whereby in case of no matching, the control access server emits and transfers to the access control system a non access signal, while in case of matching, an access signal is transmitted to the control access system.

Preferably, in case of emitting and transferring an access signal by the control access server to the control access system, the control access server attaches to a coding element selected from the group consisting of the first coding element and the second coding element an instruction for non access.

Most preferably, the said instruction for non access is transferred by the central access server to the mobile communication device.

In a specific embodiment, the said instruction for non access is transferred by the central access server to the mobile communication device, said instruction comprising a temporary instruction limiting the use of at least one function selected among the group consisting of camera and recorder during the determined time period of access.

According to a still further embodiment of the invention, the method is a method for securing the access of a person in an area through a protected area associated to an access control system, whereby the said person is provided with a mobile communication device with a wireless application enabling at least the mobile communication device to communicate with a control access server via a wireless system, said mobile communication device being provided with a screen suitable for viewing at least a QR Code, while the access control system is associated at least to a scanning device suitable for scanning at least a QR-code, as well as to a communication system for communicating with the control access server,

whereby the said method comprises at least the following steps:

downloading step on the mobile communication device of the said person of a control access application, said downloading step requiring at least one registration step with the control access server, whereby the mobile communication device of the said person is provided with a registered control access application associated to at least a secret mobile communication device identifying code which is secret for the said person, but which is readable by the control access server through a wireless system, whereby the control access application is provided with an algorithm adapted to generate at a selected time period a variable portion of a QR code which is function of (a) the selected time period, (b) at least a parameter function of the secret mobile communication device identifying code and (c) at least a parameter function of the validity time period of the QR code;

sending to the access control system by the said person via the registered control access application of the mobile communication device through the wireless system, an access request to the protected area within a determined time period of access;

receiving the access request to the protected area within said determined time period of access, as well as the said secret mobile communication device identifying code or a parameter function of the said secret mobile communication device identifying code, by the control access server;

authentication the said secret mobile communication device identifying code or parameter function of the said secret mobile communication device identifying code by said control access server, so that the said control access server determines in a request validation step whether for the authenticated secret mobile communication device identifying code, the access request to the protected area within said predetermined time period of access is a validated access request for the authenticated secret mobile communication device identifying code;

after confirmation by the request validation step that the access request to the protected area within said predetermined time period is a validated access request for the authenticated secret mobile communication device identifying code, generating an access QR code by the control access server, said access QR code comprising at least (a) a first coding element enabling to identify the said person or the mobile communication device of the said person, (b) a second coding element enabling to identify a validity time period for the QR Code and (c) a coding element resulting from an algorithm operation based at least on a parameter function of the secret mobile communication device identifying code and on a parameter function of the validity time period;

transferring the said access QR code, by the control access server to the mobile communication device of the said person, via said wireless system;

receiving and memorising the said access QR code by the said mobile communication device;

before that the said person tries to have access to the protected area, computing by the mobile communication device the variable portion of a QR code which is function of (a) the selected time period, (b) at least a parameter function of the secret mobile communication device identifying code and (c) at least a parameter function of the validity time period of the QR code, and generating an access QR code;

loading the said access QR code on the screen of the mobile communication device of the said person, said loaded access QR code comprising at least (a) the first coding element enabling to identify the said person or the mobile communication device of the said person, (b) a second coding element enabling to identify a validity time period for the loaded access QR Code or amended access QR code and (c) a third coding element corresponding to said variable portion of the QR code;

scanning the access QR code loaded on the screen of the mobile communication device of the said person by the scanning device associated to the access control system, whereby generating a scanned access QR code comprising at least the first coding element, the second coding element and the third coding element;

transferring at a selected transfer timing within the selected time period, the scanned access QR code by the access control system to the control access server;

reading the scanned QR code by the control access server so as to read the at least first coding element, second coding element and third coding element, and determining the selected transfer timing the selected time period;

computing by the control access server a computed third coding element from the selected time period, the first coding element or parameter thereof and the second coding element or parameter thereof;

checking by the control access server whether said computed third coding element or a parameter thereof having to match with the third coding element of the scanned QR code or parameter thereof, as well as whether at least (a) said first coding element or a coding parameter at least function of the first coding element, (b) said second coding element or a parameter function of the second coding element are matching to a valid access authorisation to the protected area for the said person at a checking time comprised within a time period starting at most 30 minutes before the said determined time period of access and ending at most at the end of the determined time period of access;

whereby the control access server transfers to the access control system a non access signal for the said person at least for a non matching case selected from the group consisting of the not matching case of the computed third coding element or parameter thereof with the third coding element of the scanned QR code or parameter thereof and the not matching case of (a) said first coding element or a coding parameter at least function of the first coding element and (b) said second coding element or a parameter function of the second coding element with the said valid access authorisation, while the control access server transfers to the access control system a valid access authorisation signal in case of the matching of the computed third coding element or parameter thereof with the third coding element of the scanned QR code or parameter thereof and the matching of (a) said first coding element or a coding parameter at least function of the first coding element and (b) said second coding element or a parameter function of the second coding element with the said valid access authorisation.

Advantageously, the step of generating an access QR code by the control access server is adapted for generating a QR code comprising at least a first coding element enabling to identify the said person or the mobile communication device of the said person, a second coding element enabling to identify a validity time period for the QR Code, as well as a third coding element resulting from an algorithm operation, while in case of matching of the first coding element and the second coding element the checking step by the control access server computes from the said first coding element and second coding element a computed third coding element and determines whether the computed third coding element matches with the third coding element of the scanned QR code, whereby in case of no matching, the control access server emits and transfers to the access control system a non access signal, while in case of matching, an access signal is transmitted to the control access system.

Preferably, in case of emitting and transferring an access signal by the control access server to the control access system, the control access server attaches to a coding element selected from the group consisting of the first coding element and the second coding element an instruction for non access.

Most preferably, the said instruction for non access is transferred by the central access server to the mobile communication device.

In a specific embodiment, the said instruction for non access is transferred by the central access server to the mobile communication device, said instruction comprising a temporary instruction limiting the use of at least one function selected among the group consisting of camera and recorder during the determined time period of access.

### BRIEF DESCRIPTION OF THE DRAWINGS

For the description of embodiments of the computer implemented method reference is made to FIGS. 1 to 5 representing possible communicating elements participating to the implementing of the method, as well as possible communication transfers between said elements.

FIGS. 6A and 6B are flow charts of another method of the invention, advantageously as being an add-on of the method of FIGS. 1 to 5.

FIGS. 7A to 7D are flow charts of a specific method of the invention.

FIGS. 8A and 8B are still flow charts of an embodiment of a preferred method of the invention or steps of part of method of the invention.

FIGS. 9A, 9B, 9C, 10A, 10B and 11A to 11C are schematic flow sheets showing various steps of three embodiments of method of the invention.

### DETAILED DESCRIPTION OF THE INVENTION

The method of the invention is for example a computer implemented method for assistance for a predetermined asset (1, 1bis, 1ter) characterised by asset parameters including at least its type (such as printer, scanner, copier, fax, computer, etc) or a sign or tag adapted for characterising at least its type and advantageously its location or a sign or tag adapted for characterising its location, especially in a building (B, address, room R1, R1bis, R1ter, floor), more specifically from In-Map or other mapping information provider service with full customer's address

And by assets: Site/Building/Floor, to an end-user having a mobile communication device (MCD, the end-user can also have a plurality of mobile communication device MCD1, MCD2, and the end-user can comprise a plurality of people or employees) with a scanning element (SC, scanning element means any element suitable to take a picture of a sign or mark, advantageously with colour sensors. The scanning element is for example a camera or camera sensor which is mobile or not with respect to the mobile communication device. The scanning element or camera can be embedded or can be connected to the mobile communication device), said end-user mobile communication device (MCD) being adapted to communicate with a computer system for assistance (CSA).

In said figures, the following references designate:
1,1bis, 1ter: assets, like printers, copiers
R1, R1bis, R1ter: room
B: Building
A: Asset
CSA or MW: computer system for assistance, central computer system
QR1, QR1bis, QR1ter: QR code for respectively asset 1, 1bis, 1ter
MCD, MCD1: Mobile Communication Device
SC: scanning function
DB: database
EU: end user
SP: service provider
SCP: scannable parameter of an asset
APP: application
RA: Request Assistance
ACS: assistance control step
AM: Assistance message
PR: protected room/area
ADB: Asset Data Base
KDB: Key Data Base
WEB UI: web consulting service company
MW SP: central computer system for service provider
MW EU: central computer system for End user
APP-EU: application to be downloaded for End user
APP-SP: application to be downloaded for the service provider
WEB UI EU: web consulting service company, part for End user
List View (MW EU): reporting list possible service provider
List View (MW SP): list of tickets requiring assistance
QR Generator: generator of QR code
ADM: administration works for the End user or for the Service provider
Reports: reporting towards the End user or towards the Service provider
Mail template: mail formatting for sending message
Email server: server function of the computer system
Mail to 1 Addr Free: Mail sent to one further address (free of charge)
Auditor: End user master computer receiving the QR Code and transferring information about the asset(s) to the computer system MW
IM GO: Application enabling the end-user to define the In-Map location of the assets by the End-user
IM Print Lic: Application for the service provider to have location of the asset via In Map Application
F1: transfer of instructions to generate QR code and key code to Code generator by the central system, after online purchase by the End-User, or transfer of instructions to send supports with QR code or Tag (such as RFID tags), for example by post, advantageously after online purchase by the end-user.
F2: transfer of the generated QR code or Key code or password or activation code to the auditor of the End-User for enabling the auditor to scan the QR code or the Tag which has been paid.
F3: the auditor defines the location, type of asset, etc. corresponding to an asset. He uploads paired device/code.
F4: the end-user transfers information of the asset corresponding to the QR code, or pairs the QR code or other means of labelling for generating an update of mapped devices or assets provided with QR codes/tags (such as RFID)
F5: the computer system transfers information and reports to web consulting service company providing support for the End-user(s) or support for the Service Provider(s)
F6/F6′: transfer of information directly or indirectly through the central computer system MW, between the end user and the service provider
F7: in case of payment of the annual fee for the use of the Application, the central computer system sends at least one confirmation mail free to an address
F8: in case of request of assistance, the QR code is scanned, by a mobile communication device of the end user. By scanning said QR code the Application for end user can be free downloaded
F9: in case the End user has the required authentication key or has the required password (possibly stored in a memory of the mobile communication device, so as to enable automatic connection), he can send a ticket requiring assistance with the QR code or data of the tag attached to the asset
F10: the central system determines the location of the asset for which assistance is required (where available), and shows said location or rough location on a map
F11: the central system sends a ticket for assistance (information about the problem, type of asset, etc.), with at least rough location of the asset requiring assistance, as well as a direct mail to various possible service providers which are under subscription. The service provider can (for example in a paid version, such as in a version in which the service provider has paid a subscription fee), chat on his APP with the sender of the request (end-user) and the sender (end-user) can answer back with more information, picture of the device or the problem etc.
F12: For end-users with “assign” rights for assigning QR code/Tag to an asset, in case of new QR code/Tag to be assigned to a new asset, the Mobile communication device of the end user can be used for creating asset/device input data fields, said data fields being transferred with QR code/authentication code check and transfer of information for uploading in the database the “paired device/asset” corresponding to the QR code
F13: the central computer system generates, with In Map application or with a standalone application or other localisation application, a library of assets for each specific end-user and shows the location of the different assets of said end user in a mapping system, enabling then the end-user to control the exact location of the assets.

Advantageously, in the method of the invention, given the recognition of the asset because of serial # or other means, these assets can be categorised, but also the users can be categorised.

Asset categorising: Depending on the type of asset, the pop-up menu on the system (App) will show the correct menu with the choice of the correct messages to use. (in other words, there is no request for coffee on a printer, but the printer menu can ask for a toner, a repair for a printer etc.

User categorising: Depending on the type of user in an organisation, automatically the correct part of the data can show up.

Example of user categorising:
The supplier of the fire extinguisher receives the serial number, contract type and sales date.
The technician sees expiry date and service history
The end user sees asset nbr, picture, manual and next service date interval.
Etc.

The method of the invention is a computer implemented method for assistance for a predetermined asset (1, 1bis, 1ter) characterised by asset parameters including at least its type (such as printer, scanner, copier, fax, computer, etc) or a sign or tag adapted for characterising at least its type and advantageously its location or a sign or tag adapted for characterising its location, especially in a building (B, address, room R1, R1bis, R1ter, floor), more specifically from In-Map or other mapping information provider service with full customer's address

And by assets: Site/Building/Floor, to an end-user having a mobile communication device (MCD, the end-user can also have a plurality of mobile communication device MCD1, MCD2, and the end-user can comprise a plurality of people or employees) with a scanning element (SC, scanning element means any element suitable to take a picture of a sign or mark, advantageously with colour sensors. The scanning element is for example a camera or camera sensor which is mobile or not with respect to the mobile communication device. The scanning element or camera can be embedded or can be connected to the mobile communication device), said end-user mobile communication device (MCD) being adapted to communicate with a computer system for assistance (CSA).

According to the invention, the method comprises the following steps:
loading an application (APP) on the mobile communication device (MCD, Mobile communication device means a device suitable or able to communicate wireless with a network, such as GSM phone, or other wireless mobile telecommunication device) of the end-user for secure communicating with the computer system for assistance (CSA) and/or for communicating after an authentication process with the computer system for assistance, said authentication process being advantageously operated at least partly within the mobile communication device of the end-user, said APP is for example available to an end-user after registering and/or payment of a registration fee, said APP being available via a registration computer system which is advantageously different from the computer system for assistance, even if the computer system for assistance receive information for the computer system for registration (CSR, for example in order to check the registration of the end-user or the registration status of the end-user (such as end-user with prepaid assistance or end-user with insured assistance or end-user within the guarantee term, etc.) (Preferably, the APP is provided with a security system, whereby only people from within the organisation can access assets on the system within that organisation. Outsiders cannot scan and view any data unless authorised).

An App for non “in-company” assets will not need this security system and can be easily set up for communications between end-user and service provider (probably mostly in a Business to Consumer environment;
defining a security key code (KC by the computer system for assistance CSA) or a password enabling/authorising communication between the mobile communication device and the computer system for assistance for the said predetermined asset (1) (possibly for a plurality of assets 1,1bis,1ter);
storing the security key code (KC) or the password in a database (DB) in communication with the computer system for assistance (CSA) for identifying an end-user (EU), said key code (KC) is transmitted to the Mobile communication device of the end-user, while the password (authentication password) is sent to the computer system for storing it in the database (most preferably the APP requires a confirmation of the password), so as to enable the central system able to recognise the end-user using the APP, or the password (authentication) is defined by the central system and is sent to the end user using the APP by a message, such as an electronic message, a SMS, email, etc.;
opening the application on the mobile communication device (MCD) on the mobile communication device (MCD), and authentication of the end-user with the security key code (KC)/password for enabling communication between the mobile communication device (MCD) and the computer system for assistance (CSA);
scanning a QR code or another tags (such as RFID, etc.) (QR1) attached to the predetermined asset (1) through the scanning element (SC) (scanning element is used in the present specification as meaning a means able to read at distance the code or tag or a picture. The scanning element can be a camera or a picture sensor (mobile or not)) of the mobile communication device of the end-user,
transmitting by the end-user mobile communication device (MCD), the scanned QR-code attached to the asset (In the present specification scanned QR code means also a data issued from the scanned or pictured QR-code, for example after a conversion process) and/or information from a tag attached to the asset (which means also in the present specification a data issued from the scanned or pictured Tag, for example after a conversion process), as well as possibly some asset parameters (as trademarks, serial number, years, etc.) of the asset, in case the QR-code or tag is not yet paired to a type of asset, to the computer system for assistance (CSA) (Advantageously, following the information received from the end-user, the central system edits a QR-code to be attached to the asset or a message for activating a tag present on the asset, so as to recognise it. This enables to have a QR code or a Tag with substantially no data open to unauthorised end-user for the specific asset. The method is thus able to build 1. Unique QR code or tag (RFID or other) or numbers, recognisable only by mobile device with the APP. 2. A “pairing” technique whereby the Asset is paired to the Unique QR code/number or tag. 3.

Preferable a web-application which will allow to manage the functionalities.

### Examples

Specific menus used in a certain industry (print, coffee machine, . . . )

Specific service providers linked to certain machines

Specific service providers linked to certain functionalities in the menu (e.g. the toner supplier can be different to the technician repairing the machine, but both functionalities exist in the print menu);
registering the asset (1), at least by storing the scanned QR-code/tag attached to the asset, as well as possibly some of the said asset parameters in an asset database (DB) in communication with the computer system for assistance and/or by registering the asset by pairing the unique number/identifying code on the QR code/tag to the device descriptions in the system or in the asset database (DB).
opening the application by the end-user mobile communication device (MCD) and logs-in (said logs-in can be automatic and/or through use of password);
scanning the QR-code (QR1) or tag attached to the predetermined asset (1);
possibly, but advantageously the APP of the end-user mobile communication device checks whether the end-user is authorised to communicate with the central system for sending an assistance request for the predetermined asset (1) (for example checking payment of the necessary annual or periodic fee, account sufficient for providing the requested assistance, etc.). The APP of the end-user mobile communication is for example provided with a memory status with an access data provided from the central system, said access data varying for example between a first access data enabling transfer of a request for assistance, or a second access date preventing transfer of a request for assistance, but enabling communication with the computer system for renewing the subscription or for funding the account for assistance works;
transferring, possibly after third party control, the QR-code (QR1) or data from the tag of the predetermined asset (1), information about an assistance request for an assistance required for the said asset, and possibly the key code or security key code (KC), for example in case the APP of the end-user mobile communication device check whether the end-user is authorised to communicate with the central system for sending an assistance request for the predetermined asset (1), to the computer system for assistance (CSA). Advantageously, when receiving the assistance request from the end-user mobile communication device, the computer system for assistance is also advantageously controlling the validity of the transmission, for example whether the end user has paid his annual fee for assistance and/or whether the account of the end-user is sufficient for the payment of the required assistance, or simply whether the End-User is on the list of the Central computer system of the company;
in case of transfer of a key code or security key code (KC) controlling whether the QR-code (QR1)/tag attached to the predetermined asset (1) is associated to the key code or security key code (KC), for authorising the computer system (CSA) to provide an assistance in reply to the assistance request. When controlling the key code (KC), the computer system for assistance is also advantageously controlling the validity of the transmission, for example whether the end user has paid his annual fee for assistance;
in case the QR-code (QR1) or tag attached to the predetermined asset (1) is not associated to the security key code or key code (valid) or in case the computer system determines a problem with respect to the validity of the transmission (for example the data of the RFID or the QR Code is expired or unknown by the computer system and/or for example checking payment of the necessary annual or periodic fee, account sufficient for providing the requested assistance, etc.), the computer system for assistance sends to the end-user mobile communication device an error message, while in case the validity of the transmission from the end-user communication device for the predetermined asset is confirmed by the computer system for assistance (for example when the QR-code attached to the predetermined asset is associated to the security key code or key code (KC) or in case the annual/periodic fee is duly paid, etc.), the computer system for assistance sends to the end-user mobile communication device (MCD) at least a message confirming reception of the assistance request or a message relating to the providing of assistance by a service provider in relation to assistance request and/or after receiving a ticket from the end-user, for example a ticket selected by the issue type, the assistance type, the asset type, etc., and
contacting a selected service provider selected from a database in communication with the computer system for assistance for providing him at least information about the parameters of the asset consisting of its type and advantageously controlling and communicating its location in a building (such as address, floor level, path on the floor towards the room where the asset is located, as well as other data, such as authentication access code valid only within a specific timeframe), as well as information relating to the assistance request and the sender of this request (said information and others can be transferred between the end-user and the selected assistance provider, for example by chat communication, email, skype, etc.).

The invention relates also to a computer implemented method as disclosed hereafter, but advantageously as an embodiments of the computer implemented method disclosed here above.

The computer implemented method is a method for controlling one or more assets with consumable goods. The access by an end-user to said one or more assets is protected by a control access system, which, after checking the authorisation attached to the APP (application) of the end-user mobile communication device, authorises or not the end-user to have access to consumable goods from one or more assets.

Said method comprising the steps:
scanning the QR-code or tag attached to a predetermined asset with consumable goods (possibly the consumable goods can also be provided with a QR-code or a tag) by the end-user mobile communication device;
checking the authorisation attached to the end-user mobile communication device, possibly through a communication with the central system and/or with request with a password;
after control of the authorisation to access to the consumable goods from the predetermined asset, opening of a menu of the application providing information about consumable goods available at the predetermined asset (for example when scanning the QR code of a coffee machine, the menu will present the various possible options available, such as milk, sugar, cookies, etc., with the option to report a break of coffee, milk, sugar, etc. or with the option to report to the central system the type of consumables consumed, whereby enabling the central system to determine the consumed goods for one or more rooms. When scanning the QR or a printer, the application will provide a menu with various options, like type and number of copies to be done, reporting problem(s), like low toner level, paper jam, bad printing, etc., for enabling the central system to determine the ordering of consumables, and/or the supply of assistance works, and the priority thereof);
encoding by the end-user on his mobile communication device of at least the number and type of consumable goods which will be consumed by the end-user;
sending by the end-user mobile communication device to said central system of at least the number and type of goods which will be consumed by the end-user;
advantageously sending by the central system access information to the predetermined asset, authorising the end-user to have access to the type and numbers of consumable goods at the predetermined asset;
the central system computes the type and number of consumable goods used by end-users for each assets with consumable goods, whereby determining automatically in function of a stock of consumable goods still available,
   a) whether one or more consumable goods have to be ordered at one or more suppliers, whereby automatically order from one or more suppliers to supply the necessary consumable goods;
   b) whether one or more assets have to be refilled and/or cleaned and/or maintained by an assistant, whereby sending appropriate message to the said appropriate assistant (this enables to keep the assets to be operable substantially all the time); and
   c) possibly, but advantageously, when the number of consumables used at one or more assets exceeds a predetermined level, sending a control signal to said one or more assets for blocking further access to said consumables and/or to said one or more assets. (this enables to detect possible unauthorised use or theft for one or more consumable)

According to an embodiment for a computer implemented method controlling one or more assets with consumable goods located within a room provided with a control entrance door or gate provided with a control system, whereby the access by an end-user to said room is protected by a control access system, which, after checking the authorisation attached to the APP (application) of the end-user mobile communication device, authorises or not the end-user to have access to said room, said method comprising the steps:
scanning the QR-code or tag attached or associated to the door or gate or control system by the end-user mobile communication device;
checking the authorisation attached to the end-user mobile communication device, possibly through a communication with the central system and/or with request with a password (it enables to give access to authorised end-user to the assets present in one room, and to render the end-user responsible for the assets present in the room, whereby enabling a quick reporting in case of damage to one or more assets and a quick reporting of possible removed assets);
after control of the authorisation to access to the room, opening of a menu of the application providing information about one or more assets available within said room by the end-user, as well as possible consumable goods available at the predetermined asset or assets for the end-user, and possibly the one or more assets for which the availability is not authorised to the end-user;
encoding by the end-user on his mobile communication device of at least the number and type of consumable goods which will be consumed by the end-user (it enables to have an instant view of the consumed goods in one or more rooms, as well as a view of the consumed goods per end-user, as well to have a double check of possible disappeared consumed goods);
sending by the end-user mobile communication device to said central system of at least the number and type of goods which will be consumed by the end-user;
advantageously sending by the central system access information to the predetermined asset, authorising the end-user to have access to the type and numbers of consumable goods at the predetermined asset (for example the central system authorises the end-user mobile device to command an asset for example for having one or more coffees, to print a number of pages, etc.);
the central system computes information about the use of the room, as well as the type and number of consumable goods used by end-users for each assets with consumable goods, whereby determining automatically in function of the use of one or more rooms, as well as a stock of consumable goods still available,
   a) whether one or more rooms have to be cleaned, whereby sending a message to an cleaning assistant for operating an appropriate cleaning (In case the central system knows also the agenda (day and time) of the rooms to be used, the central system advantageously determines a priority of rooms to be cleaned or maintained, and preferably determines the path to be follow by the assistant for cleaning or maintenance operation. In order to oblige the assistant to follow the rooms of the path, the assistant can only have access to one further room after operating cleaning or maintenance operations in the rooms to be operated prior to the said further room);
   b) whether one or more consumable goods have to be ordered at one or more suppliers, whereby automatically order from one or more suppliers to supply the necessary consumable goods (this enables to be able to request supply when necessary, whereby preventing the unavailability of one or more consumable goods);
   c) whether one or more assets have to be refilled and/or cleaned and/or maintained by an assistant, whereby sending appropriate message to the said appropriate assistant; and
   d) possibly, but advantageously, when the number of consumable goods used at one or more assets or in one or more rooms exceeds a predetermined level, sending a control signal to said one or more assets for blocking further access to said consumable goods and/or to said one or more assets and/or to said one or more rooms.

Advantageously, the menu of the application relating to the authorised use of one or more assets or to the authorised use of the room request from the end-user after using the said one or more assets to send to the central system a signal corresponding to a correct use or to the presence of a problem, whereby enabling the central system to automatically send a message to an appropriate assistant for controlling and/or repairing the asset having not correctly worked.

According to an embodiment, the method is a method:

in which, after being authorised by the central system to enter into the room, the application of the end-user mobile communication device opens a menu listing the assets present within the room and requests from the end-user to confirm by sending one or more signals to the central system, the presence within the room of the assets listed in the menu,

in which the central system computes automatically whether one or more assets signalled as not present in the room had to be normally present in the room, and in case one or more assets have disappeared from the room, the central system sends a signal to one or more assistants, especially one or more floor assistants, for requiring from him or them an inspection report and/or to remedial to said problem, and/or to the end-user for requiring him to make a report and/or to send some pictures showing that some asset(s) disappeared from the room.

It enables to determine whether some assets have possibly been stolen, whereby enabling a more rapid research of the possible stolen goods.

According to a detail of a further embodiment, the computer implemented method is a method

in which the assistant(s) for cleaning a room or for filling, repairing or maintaining an asset within the room is(are) provided with a mobile communication device with the appropriate application for communicating with the central system,

whereby the access by an assistant to one or more rooms is protected by a control access system, which, after checking the authorisation attached to the APP (application) of the assistant mobile communication device, authorises or not the assistant to have access to said room, said method comprising the steps:
scanning the QR-code or tag attached or associated to the door or gate or control system by the assistant mobile communication device;
checking the authorisation attached to the assistant mobile communication device, possibly through a communication with the central system and/or with request with a password;
after control of the authorisation to access to the room, opening of a menu of the application providing information about works to be operated by the assistant, at least selected from the group cleaning works, filling consumable goods within one or more assets, repairing or maintaining or replacing one or more assets, adding one or more assets available, adding one or more assets within said room;
encoding by the assistant at least information selected from the group consisting of cleaning works, consumable goods used for refilling one or more assets, repairing operation, maintenance operation, replacement operation of one or more assets, installation of a new asset in the room, tag or QR-code of the asset(s) present in the room, tag or QR-code of the asset removed from the room;
advantageously, when the assistant goes away from the room, scanning the QR-code or tag attached or associated to the door or gate or control system by the assistant mobile communication device, whereby the central control system preferably inactivates the authorisation for said assistant to re enter into the room, without further authorisation;
automatic computing by the central system, whether the operations to be operated in one or more rooms matches with signals received from one or more assistant mobile communication devices, whereby detecting the operations to be operated not matching with received assistants' signals and sending warning and/or remainder message to one or more assistant mobile telecommunication devices for the operations still to be operated;
advantageously automatic check whether the scanned tags or QR-codes of the assets for one or more rooms match with the assets assumed to be present in the one or more rooms or with the assets as checked previously by one or more assistant mobile telecommunication devices and/or by one or more end-user mobile telecommunication device, whereby the computer system determines whether one or more assets has/have disappeared from one room or has been displaced from one room to another, and whereby the computer system sends automatically to a controller mobile communication device a signal for checking/controlling the assets present in one or more rooms.

The computer implemented method of the invention is advantageously a method in which the application comprises a menu disturbance/existing problem, said method comprising at least the step of:
sending by the end-user, assistant or controller via their mobile communication devices, via the application, of signals when detecting problems to air-conditioning, electrical problems, lighting, flickering light on the ceiling, flooring, plumbing, roofing, structural problems, web access, intranet access, lighting failure, socket broken, whereby the computer system automatically determines rooms which can not be used prior one or more assistant operations and sends to one or more end-user message that one or more rooms are not suitable prior assistant operation(s).

According to preferred embodiments, the computer implemented method is a method:
in which the assets are selected from the group consisting of assets with refillable consumable goods (like printers, fridge's, coffee machines, etc.); assets with controlled access (projectors, internet access, intranet access, air conditioning, heater, electric power, lights, etc.); assets like cabinets, tables, chairs, and any other furniture). and/or
in which, the menu of the application relating to the authorised use of one or more assets or to the authorised use of the room request from the end-user after using the said one or more assets to send to the central system a signal corresponding to a correct use or to the presence of a problem, whereby enabling the central system to automatically send a message to an appropriate assistant for controlling and/or repairing the asset having not correctly worked. and/or
in which, after being authorised by the central system to enter into the room, the application of the end-user mobile communication device opens a menu listing the assets present within the room and requests from the end-user to confirm by sending one or more signals to the central system, the presence within the room of the assets listed in the menu, and/or
in which the central system computes automatically whether one or more assets signalled as not present in the room had to be normally present in the room, and in case one or more assets have disappeared from the room, the central system sends a signal to one or more assistants, especially one or more floor assistants, for requiring from him or them an inspection report and/or to remedial to said problem, and/or to the end-user for requiring him to make a report and/or to send some pictures showing that some asset(s) disappeared from the room. and/or
in which the central system determines for each assistant an operational parameter in function of the reported carried out operations, as well as possible controller or end-user report relating to one or more rooms or to one or more assets.

Now referring to the method according to the drawings, the central computer system MW can be divided in two sub systems, namely one directed for controlling communication with the end user (list view of the assets of the end user, generating the QR code or authentication code, administrative tasks (like remainder of maintenance tasks, etc.), reports on the assets and problems attached to the assets, control (CHAT) communication with the selected Service Provider, and

another directed for controlling communication with the possible service providers or with the selected service provider. (list view of possible assistance tasks and location, generates a password enabling the selected service provider to have direct access to the information of the asset, the assistance required, the exact location with mapping thereof, administrative work (such as customer satisfaction), reports on the tasks done, etc.

The computer implemented method of the invention has one or more of the following characteristics:

the step of registering the asset further comprises the transmission of a serial number of the asset, while before registering the asset, the computer system controls whether an asset having the said serial number has already been registered, whereby in case of already registered, the computer system sends an error message to the end-user mobile communication device.

the computer system for assistance is adapted for supplying to the selected service provider an In-map description of the building, or a description from a standalone application, where available, adapted to disclose a path for reaching the said asset where available.

The computer implemented method comprising the further steps of:
receiving by the computer system for assistance from the selected service provider a date and an hour range for the assistance service, where needed, and
communicating to the end-user the said date and hour range for the assistance service, as well as information about the service provider.

The computer system sends a message to the end-user and to the service provider a reminder message reconfirming the date and hour range for the assistance service where needed.

The service provider has a mobile communication device with scanning function, whereby the selected service provider scans the QR-code/tag attached to the asset before and/or during and/or after the assistance service, and sends a message to the computer system for assistance and/or to the end-user, for confirming the start and/or end of the assistance service by the service provider.

The computer implemented method of the preceding claim, in which the computer system for assistance sends a message to the end-user for receiving a feed-back message of the assistance.

The computer implemented method comprising the steps of:
defining a QR-code/tag by the computer system for the predetermined asset and sending the said QR-code/Tag (i.e. any readable information, advantageously unique numbers, paired with one specific device) to the end-user of the said predetermined asset;
or communicating the said QR-code/tag by the mobile communication device to a printing system or to a computer connected to a printer accessible to the end-user or to a writable tag;
printing the QR-code on a support or writing the received tag on the writable tag so as to form a written tag, and
attaching the support with the printed QR-code or with the written tag to the asset by the end-user.

The end-user has several mobile communication devices, which are each adapted for
scanning the QR-code/tag attached to the predetermined asset; and
transferring the QR-code/tag of the predetermined asset, information about an assistance request for an assistance required for the said asset, as well as the security key code or password or authentication code, to the computer system for assistance;

in which the computer implemented method has the further step of controlling when receiving from one of the several mobile communication devices a QR-code/tag attached to the predetermined asset, whether an assistance request for the said predetermined asset has already been transmitted to the computer system, and transmitting to the said one of the several mobile communication devices, a message comprising the date and hour range for the assistance service, as well as information about the service provider for said assistance service.

The computer implemented method has the further step of transmitting to several, or all the said several mobile communication devices of the end-user, a message comprising the date and hour range for the assistance service, as well as information about the service provider for said assistance service.

The computer implemented method further comprises the steps of receiving by the computer system for assistance from one or more mobile communication devices one or more remarks on the assistance request, and of transmitting one or more of said remarks to the service provider.

The computer implemented method further comprises the step of generating a report comprising the list of required assistances, the one or more different service providers for said required assistances, and the date and hour range for each required assistance, and the step of transmitting said report to one or more mobile communication devices.

The computer implemented method further comprises the steps:

Sending by the selected service provider or by the computer system for assistance to the end-user mobile communication device a payment request for a specific amount on a specific account as confirmation of the required assistance request;

Payment by the end-user of said specific amount on said specific account;

Sending a message to the end-user confirming payment for the assistance request.

The asset requiring assistance is located in a protected area of the building, said protected area being protected by an authorization key, said method further comprising the step of:

Sending to the selected service provider an authorization key authorizing the service provider to enter the said protected area for a date and an hour range for the assistance service.

The computer system for assistance sends a confirmation message by email to the end user, as well as to the service provider.

after the assistance of the asset by the service provider, the central computer system sends to the end-user mobile communication device a satisfactory request for satisfactory evaluation (quoting) of the service provider.

in case the QR-code/tag attached to the predetermined asset is associated to the security key code the computer system for assistance sends to the end-user mobile communication device at least a message confirming reception of the assistance request and a message with a series of possible service providers and requires from the end-user to select one service provider within the said series of possible service providers.

in case the QR-code/Tag attached to the predetermined asset is associated to the security key code/password, the computer system for assistance sends to the end-user mobile communication device at least a message confirming reception of the assistance request, determines whether a service provider suitable for assistance to the said predetermined asset for which assistance is required has already been requested for assistance of another asset within the building, and select said service provider for assistance to the said predetermined asset for enabling assistance of both assets at a same date.

The central computer system can comprise a series of computers associated the one to the other for forming a network for ensuring assistance to the end-user, even in case of problems with one or more computer.

The central system is adapted for creating a specific QR code for each asset, for sending said QR code to the end-user in a printable form, so that the end-user can print the QR code on a specific label with an adhesive layer for attaching it to the asset. Possibly the adhesive label can be sent by post. Advantageously, the QR code can also comprise also a part or section enabling to identify the end-user or the owner of the asset via the computer system for assistance, whereby enabling a double check when receiving a scan of the QR-code, i.e. whether the asset is still property of the registered end-user.

The central computer system is adapted for searching an appropriate service provider for assistance or a list of such appropriate service providers, or can send a request to a consulting service company, like WEB UI, for obtaining one or more possible appropriate service providers. Or the central computer system uses the current service providers used by the end-user. The service providers can also be simple suppliers of consumables, necessary for the devices the QR code/tag is attached to.

The central computer sends to the web consulting service a ticket requiring one or more possible services providers, said ticket being then preferably visible for the end-user (EU). The ticket is advantageously only visible by prior validated services providers (SP), the validation being for example operated after an on site control, as well as possibly after payment of a registration fee for having access to the tickets present on the web site of the web consulting service company (WEB UI). The tickets comprise information such as assistance characteristics, type of asset requiring assistance, general info about location (for example city, district thereof, etc), urgency degree for the required assistance, but preferably no mention at all of the end-user, so as to prevent direct call of a service provider (SP) to an end-user (EU). In some application, direct chat between the service provider and end-user is possible. When direct chatting, less control by the central computer exists between the service provider and end-user.

Possible service providers (SP) can then confirm directly to the central computer system of their availability to operate the required assistance, as well as date and hours frame for said assistance, and possibly possible cost and quote pricing for the assistance. The customer can possibly sign off after intervention of the technician.

In case the central computer system had information on potential service providers, for example previously registered service providers, the central computer system will send a message to said potential service providers for alerting them that a ticket is open for possible services, but that said ticket will be available only after payment of the access fee (for a term for example of one year).

For the selected supplier for the assistance services (i.e. which has paid his access fee and/or which has been selected), he will be able to have via his mobile communication device to have advantageously one or more of the following options or functions:
he will be able to receive prior his visit for the assistance, to receive information about the asset, about the present problem, and a history of the previous problems attached to said asset;
he will be able to receive a ticket where the asset is located (building, street, etc, for example with google map), as well as the way to follow within the building for reaching the asset (for example by using In-Map system or other mapping information system);
he will be able to communicate with the end-user, advantageously with copy to the central computer system or more preferably via the central computer system, in order to fix or adapt the visit, or to request further information.
in case tickets can not be transferred to the mobile communication device of the selected service provider, tickets can be routed back to another electronic address of the service provider, for example general email address of the Service provider.
copy of tickets can be sent to other people of the service provider of the organization.
various reporting can be transmitted to the service provider or from the service provider:
ticket history of the asset/device
ticket history of the end-user
details on the assistance provided
ticket history per type of problem/alert
ticket history per site
ticket history per type of printer/copier
rating of customer satisfaction for the assistance, for the technician
ticket on customer satisfaction level for the service provider with respect to other service provider.

For the end-user, the following points will be checked or available (with or without payment of an extra fee), in case the End User has paid the registration fee and that his registration is still valid (for example a fee will be required per asset per year, said price could include the charge for generating a QR code):
end-user reporting
ticket per device
ticket history per end-user
ticket per type of problem for the end user
ticket history per site
ticket history per type of printer/copier
etc
access to all visible pending problems on maps

The QR code/tag enables advantageously a mobile communication device to open the application or to download the application. Thereafter, in order to communicate an assistance request a key code or an authorised end-user will be necessary. The QR code/tag enables to determine that the asset is within the database of the Central computer system. The QR code/tag enables a unique billing system for one specific asset, as well as a continuous numbering and follow up for all amount paid for assets with QR codes/Tags. Temporary QR codes/Tags can be provided to potential end-user, said temporary QR codes/tags becoming permanent e.g. after payment of the necessary fees. In case of change of QR codes/Tags for one asset, a pairing of old and new QR-codes/Tags has to be done so as to retrieve past information of the asset.

The QR-code/Tag does not comprise readable information about the asset. Information about the asset to which is attached the QR code/Tag can only be retrieved via the central computer system.

The invention relates also to a computer implemented method as disclosed hereafter, but advantageously as an embodiments of the computer implemented method disclosed here above in FIGS. 1-5.

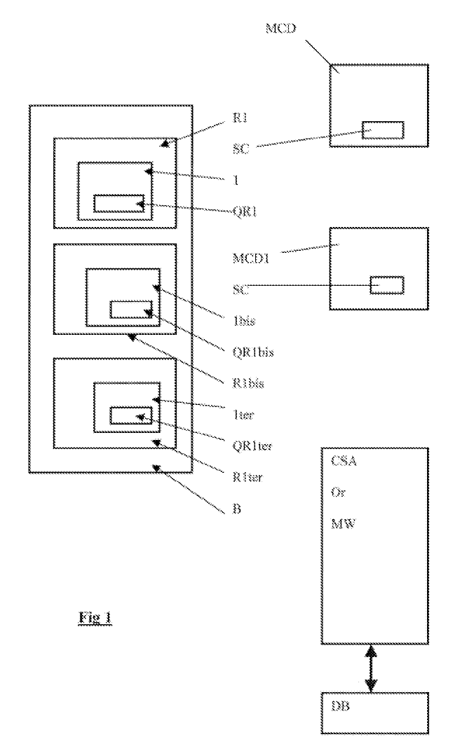

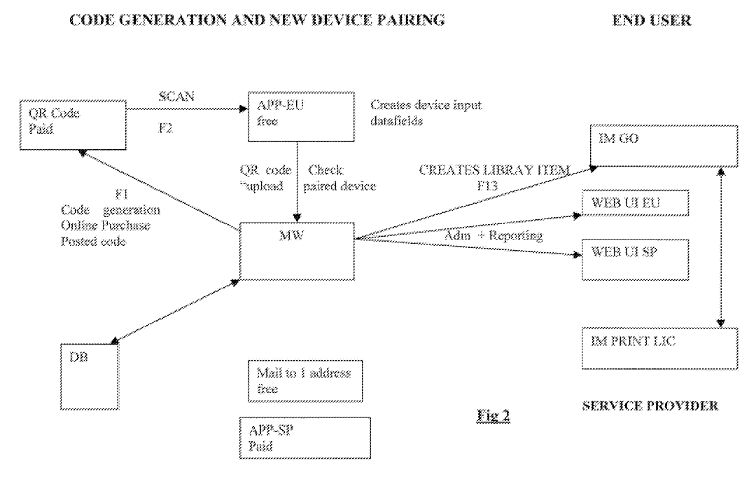

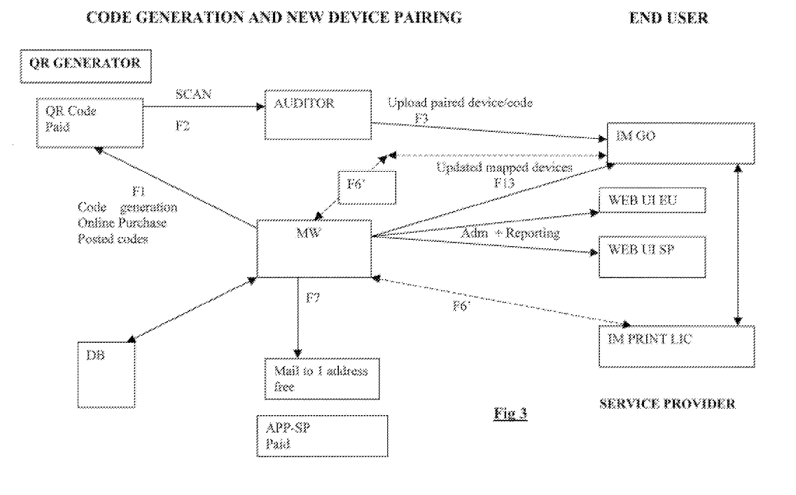

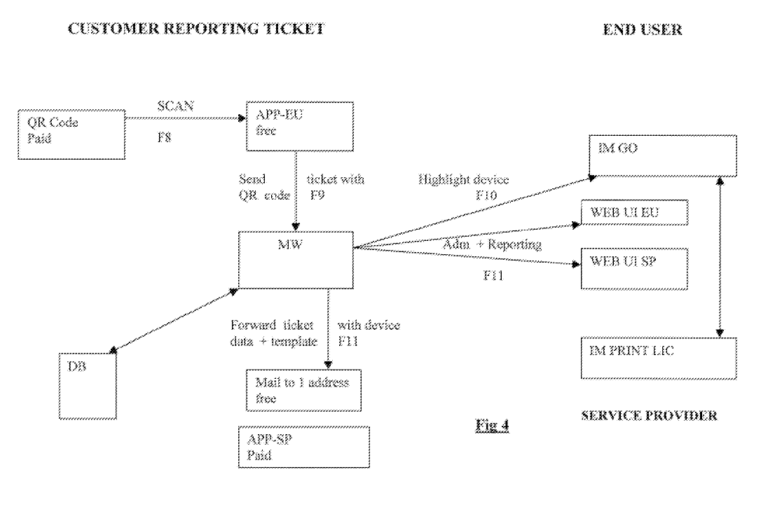

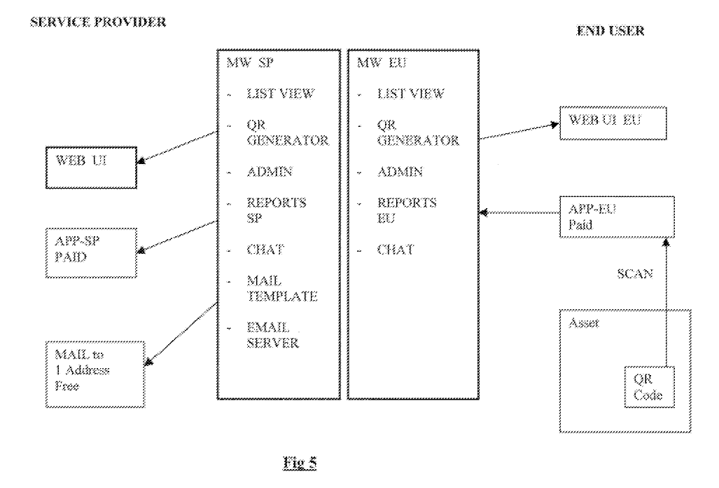

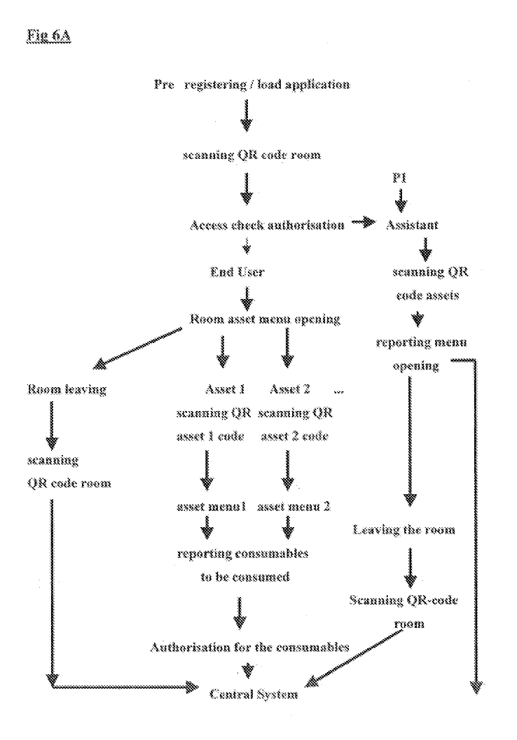

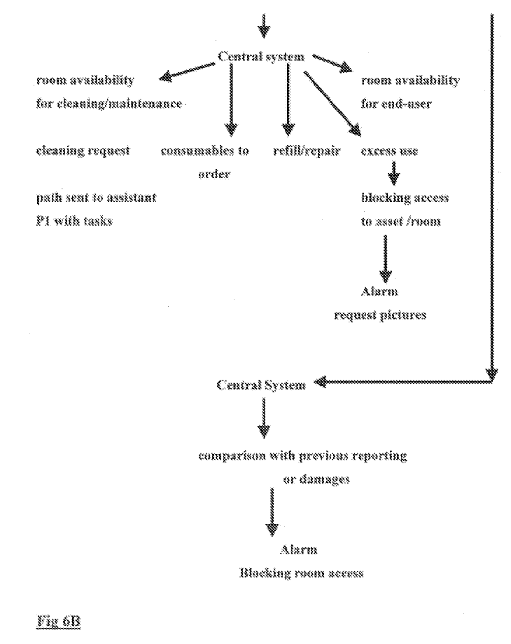

The computer implemented method of FIGS. 6A and 6B is a method for controlling one or more assets with consumable goods. After a pre registering step (like as disclosed in FIG. 1-5), the access by an end-user to said one or more assets is protected by a control access system, which, after checking the authorisation attached to the APP (application) of the end-user mobile communication device, authorises or not the end-user to have access to consumable goods from one or more assets.

Said method comprising the steps:
pre registering step;
scanning QR step of asset 1: scanning the QR-code or tag attached to a predetermined asset with consumable goods (possibly the consumable goods can also be provided with a QR-code or a tag) by the end-user mobile communication device;
Access authorisation step: checking the authorisation attached to the end-user mobile communication device, possibly through a communication with the central system and/or with request with a password;
Asset menu opening: after control of the authorisation to access to the consumable goods from the predetermined asset, opening of a menu of the application providing information about consumable goods available at the predetermined asset (for example when scanning the QR code of a coffee machine, the menu will present the various possible options available, such as milk, sugar, cookies, etc., with the option to report a break of coffee, milk, sugar, etc. or with the option to report to the central system the type of consumables consumed, whereby enabling the central system to determine the consumed goods for one or more rooms. When scanning the QR or a printer, the application will provide a menu with various options, like type and number of copies to be done, reporting problem(s), like low toner level, paper jam, bad printing, etc., for enabling the central system to determine the ordering of consumables, and/or the supply of assistance works, and the priority thereof);
reporting consumables: encoding by the end-user on his mobile communication device of at least the number and type of consumable goods which will be consumed by the end-user;
sending by the end-user mobile communication device to said central system of at least the number and type of goods which will be consumed by the end-user;
authorisation step for the consumables: advantageously sending by the central system access information to the predetermined asset, authorising the end-user to have access to the type and numbers of consumable goods at the predetermined asset;
central system computing step: the central system computes the type and number of consumable goods used by end-users for each assets with consumable goods, whereby determining automatically in function of a stock of consumable goods still available,
   a) whether one or more consumable goods have to be ordered at one or more suppliers, whereby automatically order from one or more suppliers to supply the necessary consumable goods;
   b) whether one or more assets have to be refilled and/or cleaned and/or maintained by an assistant, whereby sending appropriate message to the said appropriate assistant (this enables to keep the assets to be operable substantially all the time); and
   c) excess use control step: possibly, but advantageously, when the number of consumables used at one or more assets exceeds a predetermined level, sending a control signal to said one or more assets for blocking further access to said consumables and/or to said one or more assets. (this enables to detect possible unauthorised use or theft for one or more consumable)

According to an embodiment for a computer implemented method controlling one or more assets with consumable goods located within a room provided with a control entrance door or gate provided with a control system, whereby the access by an end-user to said room is protected by a control access system, which, after checking the authorisation attached to the APP (application) of the end-user mobile communication device, authorises or not the end-user to have access to said room, said method comprising the steps:
Scanning QR-code room: scanning the QR-code or tag attached or associated to the door or gate or control system by the end-user mobile communication device;
Access check authorisation: checking the authorisation attached to the end-user mobile communication device, possibly through a communication with the central system and/or with request with a password (it enables to give access to authorised end-user to the assets present in one room, and to render the end-user responsible for the assets present in the room, whereby enabling a quick reporting in case of damage to one or more assets and a quick reporting of possible removed assets);
after control of the authorisation to access to the room, opening of a menu of the application providing information about one or more assets available within said room by the end-user, as well as possible consumable goods available at the predetermined asset or assets for the end-user, and possibly the one or more assets for which the availability is not authorised to the end-user;
encoding by the end-user on his mobile communication device of at least the number and type of consumable goods which will be consumed by the end-user on the various asset (asset1,2,3) present in the room (it enables to have an instant view of the consumed goods in one or more rooms, as well as a view of the consumed goods per end-user, as well to have a double check of possible disappeared consumed goods);
sending by the end-user mobile communication device to said central system of at least the number and type of goods which will be consumed by the end-user, advantageously as one single reporting after opening the various assets to be used;
advantageously sending by the central system access information to the predetermined asset, authorising the end-user to have access to the type and numbers of consumable goods at the predetermined asset (for example the central system authorises the end-user mobile device to command an asset for example for having one or more coffees, to print a number of pages, etc.);
the central system computes information about the use of the room, as well as the type and number of consumable goods used by end-users for each assets with consumable goods, whereby determining automatically in function of the use of one or more rooms, as well as a stock of consumable goods still available,
   a) whether one or more rooms have to be cleaned, whereby sending a message to an cleaning assistant for operating an appropriate cleaning (In case the central system knows also the agenda (day and time) of the rooms to be used, the central system advantageously determines a priority of rooms to be cleaned or maintained, and preferably determines the path to be follow by the assistant for cleaning or maintenance operation. In order to oblige the assistant to follow the rooms of the path, the assistant can only have access to one further room after operating cleaning or maintenance operations in the rooms to be operated prior to the said further room);
   b) whether one or more consumable goods have to be ordered at one or more suppliers, whereby automatically order from one or more suppliers to supply the necessary consumable goods (this enables to be able to request supply when necessary, whereby preventing the unavailability of one or more consumable goods);
   c) whether one or more assets have to be refilled and/or cleaned and/or maintained by an assistant, whereby sending appropriate message to the said appropriate assistant; and
   d) possibly, but advantageously, when the number of consumable goods used at one or more assets or in one or more rooms exceeds a predetermined level, sending a control signal to said one or more assets for blocking further access to said consumable goods and/or to said one or more assets and/or to said one or more rooms.

Advantageously, the menu of the application relating to the authorised use of one or more assets or to the authorised use of the room request from the end-user after using the said one or more assets to send to the central system a signal corresponding to a correct use or to the presence of a problem, whereby enabling the central system to automatically send a message to an appropriate assistant for controlling and/or repairing the asset having not correctly worked.

According to an embodiment, the method is a method:
in which, after being authorised by the central system to enter into the room, the application of the end-user mobile communication device open a menu listing the assets present within the room and requests from the end-user to confirm by sending one or more signals to the central system, the presence within the room of the assets listed in the menu (possibly, in case the central system determines a problem between the actual status of assets present in a room and the previously reported status of assets present in the room, the central system will send a message to the end-user asking him to take one or more pictures of the rooms and assets present in the room(s),
in which the central system computes automatically whether one or more assets signalled as not present in the room had to be normally present in the room, and in case one or more assets have disappeared from the room, the central system sends a signal to one or more assistants, especially one or more floor assistants, for requiring from him or them an inspection report and/or to remedial to said problem, and/or to the end-user for requiring him to make a report and/or to send some pictures showing that some asset(s) disappeared from the room.

It enables to determine whether some assets have possibly been stolen, whereby enabling a more rapid research of the possible stolen goods.

When the end-user leaves the room, he scans back the QR-code or tag of the room with his mobile device, whereby enabling the computer system to determine the availability of the room, for example for cleaning step.

According to a detail of a further embodiment, the computer implemented method is a method, in which the assistant(s) for cleaning a room or for filling, repairing or maintaining an asset within the room is(are) provided with a mobile communication device with the appropriate application for communicating with the central system,
whereby the access by an assistant to one or more rooms is protected by a control access system, which, after checking the authorisation attached to the APP (application) of the assistant mobile communication device, authorises or not the assistant to have access to said room, said method comprising the steps:
   scanning the QR-code or tag attached or associated to the door or gate or control system by the assistant mobile communication device;
   checking the authorisation attached to the assistant mobile communication device, possibly through a communication with the central system and/or with request with a password;
   after control of the authorisation to access to the room, opening of a menu of the application providing information about works to be operated by the assistant, at least selected from the group cleaning works, filling consumable goods within one or more assets, repairing or maintaining or replacing one or more assets, adding one or more assets available, adding one or more assets within said room;
   encoding by the assistant at least information selected from the group consisting of cleaning works, consumable goods used for refilling one or more assets, repairing operation, maintenance operation, replacement operation of one or more assets, installation of a new asset in the room, tag or QR-code of the asset(s) present in the room, tag or QR-code of the asset removed from the room;
   advantageously, when the assistant goes away from the room, scanning the QR-code or tag attached or associated to the door or gate or control system by the assistant mobile communication device, whereby the central control system preferably inactivates the authorisation for said assistant to re enter into the room, without further authorisation;
   automatic computing by the central system, whether the operations to be operated in one or more rooms matches with signals received from one or more assistant mobile communication devices, whereby detecting the operations to be operated not matching with received assistants' signals and sending warning and/or remainder message to one or more assistant mobile telecommunication devices for the operations still to be operated;
   advantageously automatic check whether the scanned tags or QR-codes of the assets for one or more rooms match with the assets assumed to be present in the one or more rooms or with the assets as checked previously by one or more assistant mobile telecommunication devices and/or by one or more end-user mobile telecommunication device, whereby the computer system determines whether one or more assets has/have disappeared from one room or has been displaced from one room to another, and whereby the computer system sends automatically to a controller mobile communication device a signal for checking/controlling the assets present in one or more rooms.

The computer implemented method of the invention is advantageously a method in which the application comprises a menu disturbance/existing problem, said method comprising at least the step of:
sending by the end-user, assistant or controller via their mobile communication devices, via the application, of signals when detecting problems to air-conditioning, electrical problems, lighting, flickering light on the ceiling, flooring, plumbing, roofing, structural problems, web access, intranet access, lighting failure, socket broken, whereby the computer system automatically determines rooms which can not be used prior one or more assistant operations and sends to one or more end-user message that one or more rooms are not suitable prior assistant operation(s).

According to preferred embodiments, the computer implemented method is a method:
in which the assets are selected from the group consisting of assets with refillable consumable goods (like printers, fridge's, coffee machines, etc.);
assets with controlled access (projectors, internet access, intranet access, air conditioning, heater, electric power, lights, etc.); assets like cabinets, tables, chairs, and any other furniture). and/or
in which, the menu of the application relating to the authorised use of one or more assets or to the authorised use of the room request from the end-user after using the said one or more assets to send to the central system a signal corresponding to a correct use or to the presence of a problem, whereby enabling the central system to automatically send a message to an appropriate assistant for controlling and/or repairing the asset having not correctly worked. and/or
in which, after being authorised by the central system to enter into the room, the application of the end-user mobile communication device opens a menu listing the assets present within the room and requests from the end-user to confirm by sending one or more signals to the central system, the presence within the room of the assets listed in the menu, and/or
in which the central system computes automatically whether one or more assets signalled as not present in the room had to be normally present in the room, and in case one or more assets have disappeared from the room, the central system sends a signal to one or more assistants, especially one or more floor assistants, for requiring from him or them an inspection report and/or to remedial to said problem, and/or to the end-user for requiring him to make a report and/or to send some pictures showing that some asset(s) disappeared from the room. and/or
in which the central system determines for each assistant an operational parameter in function of the reported carried out operations, as well as possible controller or end-user report relating to one or more rooms or to one or more assets.

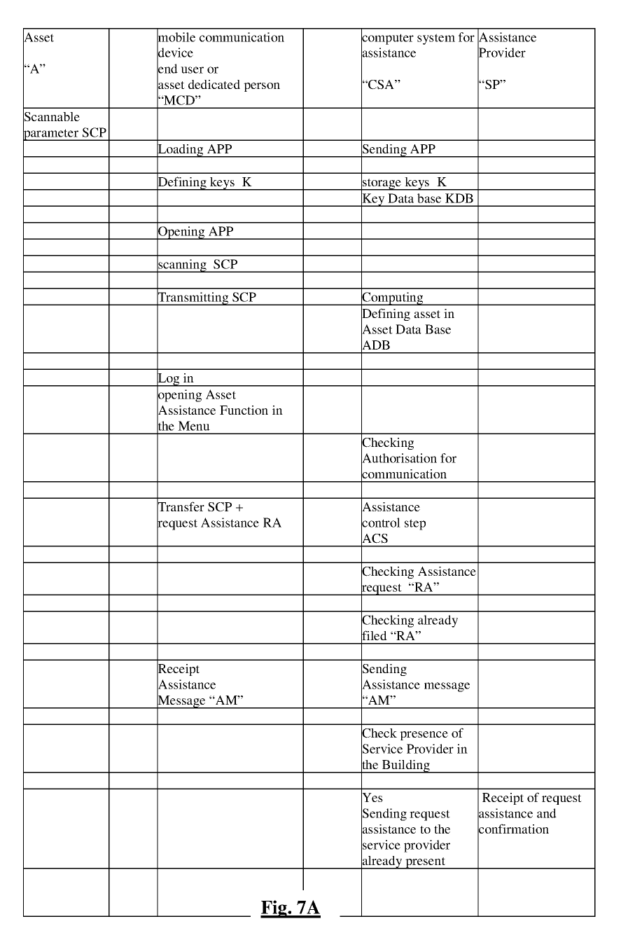

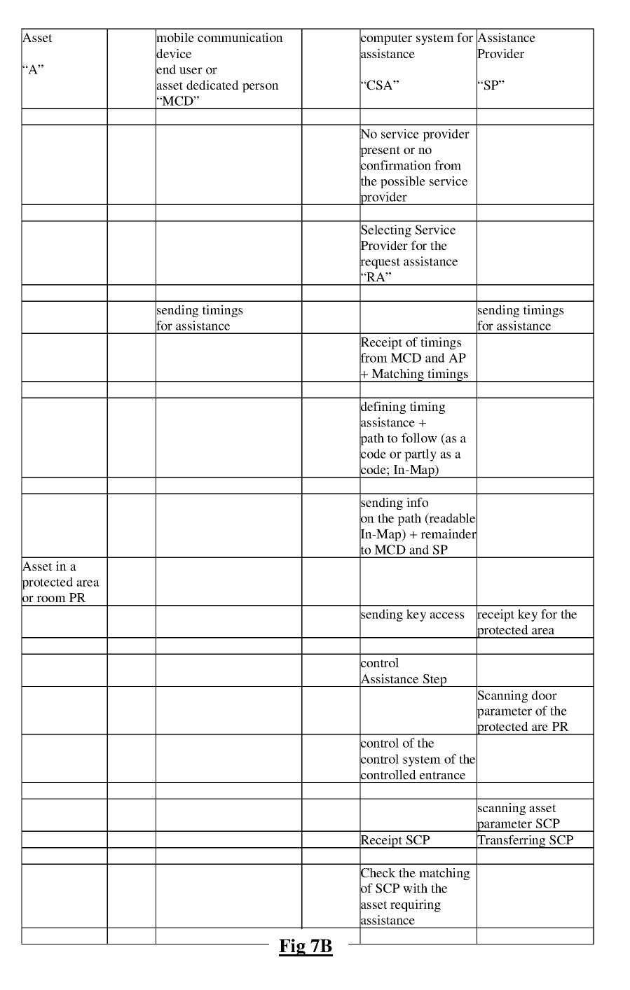

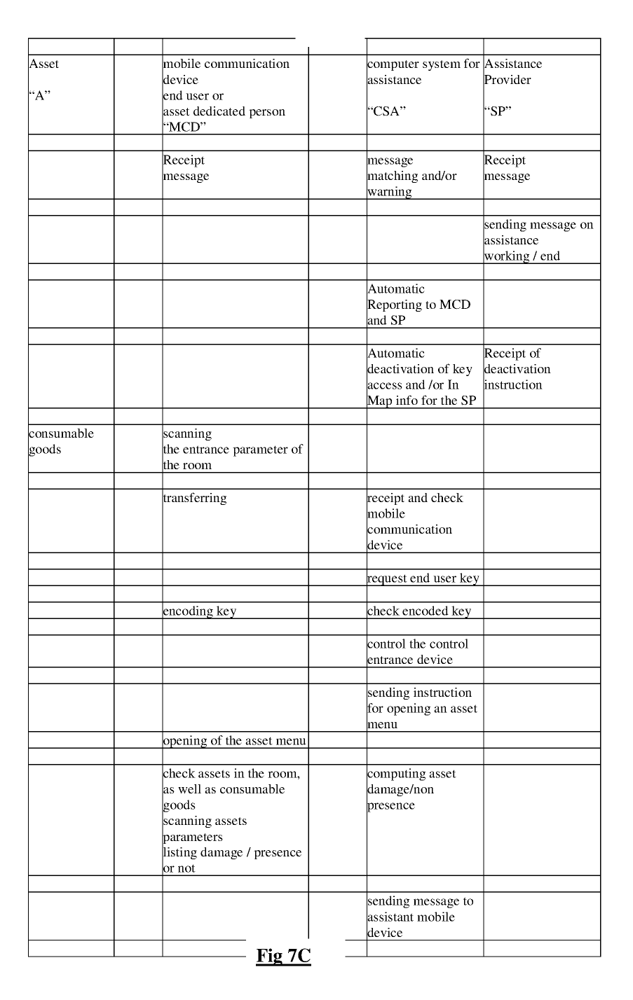

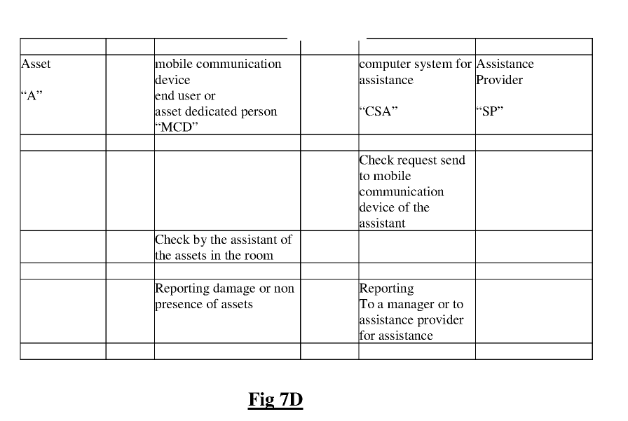

Specific methods of the invention are: (see FIGS. 7A to 7D)

A computer implemented method for assistance for a predetermined asset “A” characterised by asset parameters including at least one scannable asset characterising parameter “SP” selected among the group consisting of asset type parameter, sign adapted for characterising at least the asset type and the asset location on a site or in a building, tag adapted for characterising at least the asset type and the asset location on a site or in a building, to at least a first end-user selected among a group of end-users having each a mobile communication device “MCD” provided with a scanning element, whereby the said scannable asset characterising parameter “SCP” is attached to the said predetermined asset, said at least first end-user mobile communication device “MCD” being adapted to communicate with a computer system for assistance “CSA”, said method comprising the following steps:
loading a communication control application “APP” on the mobile communication device “MCD” of the said at least first end-user for secure communicating with the computer system for assistance “CSA” after an authentication process with the computer system for assistance “CSA”, said authentication process being operated at least partly within the mobile communication device “MCD” of the said at least first end-user;
defining, for each of a group of several end-users, at least one key “K” selected from the group consisting of security key code, password enabling communication between the mobile communication device “MCD” of an end-user of said group and the computer system for assistance “CSA” for the said predetermined asset, password authorising communication between the mobile communication device of an end-user of said group and the computer system for assistance for the said predetermined asset, and password limiting communication between the mobile communication device of an end-user of said group and the computer system for assistance for the said predetermined asset, whereby defining a plurality of different keys;
storing the said different keys “K” in a keys containing database “KDB” (said Key Data Base comprises advantageously a signature or identity of the mobile communication device of the end-user, whereby communication with the computer system for assistance is only possible for an end-user through his mobile communication device having the appropriate signature) in communication with the computer system for assistance (CSA) for identifying an end-user of said group, the said different keys being sent to the computer system for assistance which comprises instruction for storing the said different keys into the said keys containing database (KDB), so as to enable at least the computer system for assistance to implement a recognition function selected from the group consisting of a function to recognise a predetermined end-user using the communication control application “APP”, and a function for defining an authentication password to be sent to a predetermined end user by using the communication control application “APP” by a message;
opening by said predetermined end-user of the communication control application “APP” on the mobile communication device “MCD” of the predetermined end-user (said mobile communication device having preferably its unique characterizing signature or identity (international mobile equipment identity)), and recognising the predetermined end-user by the computer system for assistance by the key corresponding to the said predetermined end-user for enabling communication between the mobile communication device of the predetermined end-user and the computer system for assistance;
scanning a scannable characterizing parameter “SCP” attached to a predetermined asset “A” through the scanning element of the mobile communication device of the said predetermined end-user,
transmitting by the said predetermined end-user's mobile communication device, the scanned scannable characterising parameter “SCP” attached to the predetermined asset, to the computer system for assistance “CSA”;
computing by the computer system for assistance of the scanned scannable characterising parameter “SP” attached to the predetermined asset for registering the said predetermined asset, at least by storing the scanned scannable characterising parameter “SCP”, as well as a plurality of asset working parameters of the predetermined asset, in an asset database “ADB” in communication with the computer system for assistance “CSA”. Advantageously, the location of the asset in the building will also be defined during the registration step. Advantageously, the step of registering the asset further comprises the transmission of a serial number of the asset, while, before registering the asset “A”, the computer system for assistance controls whether the predetermined end-user mobile communication device is authorised to communicate with the computer system for assistance for the step of registering the asset, and in the affirmative, whether an asset having the said serial number has already been registered, whereby in case the predetermined end-user mobile communication device “MCD” is not authorised to register said asset, the computer system for assistance sends an error message to a mobile communication device “MCD” of at least a person selected from the group consisting of the end-user and the asset dedicated person, while in case the asset “A” is already registered in the asset database “ADB”, the computer system for assistance “CSA” sends an error message at least to the end-user's mobile communication device MCD.
opening of an assistance function of the communication control application by a predetermined end-user mobile communication device, after a logs in requiring encoding the key corresponding to the predetermined end user;
checking by the communication control application of the predetermined end-user mobile communication device, whether the predetermined end-user mobile communication device is authorised to communicate with the computer system for sending an assistance request following the scanning of a scannable characterising parameter attached to an asset,
whereby in case of authorisation of communication of the end-user mobile communication device with the computer system for assistance for the said predetermined asset “A”, transferring the scannable characterising parameter “SCP” and information about an assistance request RA for an assistance required for the said predetermined asset “A”, by the end-user mobile communication device “MCD” to the computer system for assistance “CSA”;
computing by the computer system for assistance an assistance control step “ACS” for controlling at least whether the predetermined end-user key K is authorising the said computer system for assistance for treating an assistance request from the said predetermined end-user mobile communication device “MCD”, and whether an assistance request “RA” for said predetermined asset corresponding to the transferred scannable characterising parameter is already handled by the computer system for assistance “CSA”,
sending, following the said assistance control step, by the computer system for assistance to the predetermined end user's mobile communication device at least one message “AM” selected from the group consisting of: a message advising that the predetermined end-user is not entitled to file a request for assistance for the said predetermined asset, a message confirming the prosecution of the request of assistance for said predetermined asset sent by the said end-user, and a message signalling that a request of assistance for the said predetermined asset is already handled by the computer system for assistance, and
selecting by the computer system for assistance “CSA”, at least one service provider (Assistance provider SP) selected from a database in communication with the computer system for assistance for managing the assistance request of the predetermined asset, and contacting the said at one selected service provider “SP” through his mobile communication device so as to provide him at least information about the predetermined asset “A” requiring assistance, information about the requested assistance for said predetermined asset, and information about the location of the said predetermined asset in a building;
receiving from the mobile communication device of the selected service provider “AP” and from a mobile communication device of an asset dedicated person (MCD) selected from the group consisting of the end-user and a person dedicated to manage the said predetermined asset in the building, a series of dates and hours convenient for assistance working to the said predetermined asset, and selecting in said series of dates and hours at least one date and hour for the assistance working convenient for both the selected service provider and the asset dedicated person, and confirming by the computer system for assistance, to said selected service provider and said asset dedicated person, the date and hours for the assistance work, as well as information associated to a path to follow by the selected service provider for reaching the predetermined asset in the building,

Advantageously the computer system for assistance CSA is automatically supplying to the mobile communication device of the selected service provider SP and to the mobile communication device MCD of the asset dedicated person an In-map description (advantageously in the form of an information which would be readable just before the planned assistance working, date/hours) of the path to follow in the building for reaching the asset requiring assistance, as well as a remainder message at least to the mobile communication device of the asset dedicated person and to the mobile communication device of the service provider a reminder message reconfirming the date and hour range for the assistance service.
controlling by the computer system for assistance “CSA” information about displacement of the selected service provider in the building (for example by checking passage of the service provider through door or gate requiring the scanning of access parameter), said computer system for assistance “CSA” receiving at least the following information: information from the mobile communication device of the selected service provider (“SP”) relating to the date and hour when the selected service provider enters into the building or part thereof where the predetermined asset “A” requiring assistance is located, information from the mobile communication device “MCD” of the asset dedicated person confirming the asset dedicated person is present into the building or part thereof where the predetermined asset requiring assistance is located, information about the path followed by the selected service provider in the building, information about the assistance working carried out by the selected service provider “AP”, information relating to the end of the assistance working by the mobile communication device of the selected service provider, and information from the mobile communication device of the asset dedicated person confirming the end of the assistance working by the selected service provider (when receiving information about the assistance working on the asset from the assistance provider, the computer system for assistance advantageously desactivated possible access key or information about the In-Map transferred to the mobile communication device of the assistance provider);
editing automatically by the computer assistance system a report on the carried assistance working, said report comprising at least information about the selected service provider and information about the completion of the assistance working, and
sending automatically the said report or part thereof, by the computer system for assistance, at least to the mobile communication device of the asset dedicated person.

As the service provider has a mobile communication device with scanning function, the method comprises the following further steps:
scanning by the mobile communication device of the selected service provider “SP”, the scannable asset characterising parameter SCP of the asset requiring assistance A, and sending said scannable asset characterising parameter, by said mobile communication device of the selected service provider to the computer system for assistance, before starting assistance working on the asset by the service provider,
following the receipt of said scannable asset characterising parameter SP from the mobile communication device of the selected assistance provider by the computer system for assistance, automatic checking by the computer system for assistance CSA, at least one of the points selected form the group consisting of: (a) whether the scanned scannable asset characterising parameter fits to the asset requiring assistance by the said selected service provider; (b) whether the scanned scannable asset characterising parameter fits to an asset no more requiring assistance by the said selected service provider; and (c) whether the scanned scannable asset characterising parameter fits to an asset requiring assistance at a selected time range not fitting with the date and hour previously dedicated for the assistance work;
following said automatic checking, emitting automatically by the computer system for assistance, to at least to both the mobile communication device of the selected service provider AP and to the mobile communication device MCD of the asset dedicated person, a message selected from the group consisting of (a) a message confirming that the scanned scannable asset characterising parameter corresponds to the parameter of the asset requiring assistance, (b) a warning message that the scanned scannable asset characterising parameter does not fit with the asset requiring assistance, (c) a warning message that the scanned scannable parameter asset corresponds to an asset not requiring assistance at the selected time range. This enables to prevent a non desired working on an asset and/or a risk of a working on an asset at a non desired or agreed timing, meaning a possible fraud.

In case the end-user has a series of end-user independent mobile communication devices MCD provided each with a scanning element, which are each adapted for
scanning the scannable asset characterising parameter attached to a predetermined asset; and
transferring the scanned scannable asset characterising parameter of the predetermined asset, as well as information about an assistance request for an assistance required for the said asset, to the computer system for assistance;
the computer implemented method has the further steps:
automatic controlling by the computer system for assistance when receiving at least from one of the series of the end-user independent mobile communication devices a scannable asset characterising parameter attached to the predetermined asset, whether an assistance request for the said predetermined asset has already been transmitted to the computer system for assistance, and
transmitting automatically by the computer system for assistance to at least several end-user independent mobile communication devices of the said series, a message comprising the timing (date and hour) range for the assistance service, as well as information about the service provider for said assistance service. This enables a control by several employees of the end-user to have a control on the assistance working and on the asset and timing for said assistance working.

The computer implemented method is particularly suitable for asset A requiring assistance located in a protected area or room PR of the building, said protected area being protected by a special authorisation key SAK authorising the access to the said protected area, said method further comprising at least the step of:
Sending by the computer system for assistance CSA to the mobile communication device of the selected service provider SP the special authorization key authorizing the service provider to enter the said protected area for a timing (date and a hour) range for the assistance service, at most 15 minutes before the start of the dedicated timing range (date and hour range) for the assistance service to be carried out by the said selected service provider. In this way, the complete In-Map information will only be available to the service provider on his mobile communication device only a few times before entering the building, i.e. before the agreed timing for the assistance working. Most preferably the In-Map information will be provided to the service provider step by step, meaning that when the service provider has to scan a door or gate parameter for entering a protected area, the computer system for assistance will provide the mobile communication device of the service provider further information about the path to follow after entering the protected area.

In case the computer system for assistance receives from a mobile communication device of an asset dedicated person, a scannable asset characterising parameter of a first asset requiring assistance, the computer system for assistance checks whether a service provider suitable for assistance to the said first asset for which assistance is required has already been requested for assistance of another asset within the building, and sends to the mobile communication device of said service provider for assistance of said other asset, at least a message requiring to also carry assistance work for the said first asset at a same date.

In case at least one asset is associated to at least one consumable good, whereby the access or consumption or use by a predetermined end-user to said one asset associated to said at least one consumable good is protected by a control access system, the method comprises the following steps:
checking by the computer system for assistance, whether the key attached to the communication control application of the end-user mobile communication device of said predetermined end-user authorises or not the said predetermined end-user to have access to said at least one consumable good associated to said asset in consideration,
after checking that the end-user's key authorises the access to said at least one consumable good from the predetermined asset, opening of a menu of the communication control application of the end-user's mobile communication device, said menu providing information about the said at least one consumable good available at the predetermined asset;
encoding by the end-user on his mobile communication device of at least one consumable good parameter selected among the group consisting of type of consumable good intended to be consumed, number of consumable good intended to be consumed, and combination thereof;
sending by the end-user mobile communication device to said computer system for assistance, at least the said at least one consumable good parameter;
sending by the computer system for assistance access information to the predetermined asset, authorising the end-user to have access to said at least one consumable good at the predetermined asset in accordance to the said at least one consumable good parameter;
computing by the computer system for assistance at least the type and number of consumable goods used by end-users for each assets with consumable goods, whereby determining automatically in function of a stock of consumable goods still available for said at least one predetermined asset,
   a) whether said consumable goods have to be ordered to at least one supplier, whereby automatically ordering from said at least one supplier to supply the necessary consumable goods;
   b) whether said at least one predetermined asset has to be refilled with consumable goods, whereby sending automatically a refillable message to the mobile communication device of the asset dedicated person.

In case at least one asset with consumable goods is located within a room provided with a control entrance device provided with a control system in communication with the computer system for assistance and with a scannable entrance parameter, whereby the access by an end-user to said room is protected by the control access system, which, after checking the authorisation key of the end-user mobile communication device, controls the access of the end-user to said room,
said method comprises the following steps:
scanning the scannable entrance parameter associated to the control entrance device by the end-user mobile communication device, and sending said scannable entrance parameter by the end-user mobile communication device to the computer system for assistance;
checking in a checking step by the computer system for assistance whether the end-user mobile communication device is listed in an identification database comprising identification parameter of a series of end-user mobile communication devices with authorisation key;
in case the said checking step confirms that the end-user mobile communication device has his identification parameter into the identification database, requiring from the end-user to encode his authorisation key and to send said authorisation key by the end-user mobile communication device to the computer system for assistance;
checking the authorisation key received from the end-user mobile communication device by the computer system for assistance, so as to determine whether said received authorisation key is associated to an authorisation to enter the room;
in case the checking step confirms that the received authorisation key from the end-user mobile communication device is associated to an authorisation to enter the room, sending by the computer system for assistance of an instruction to the control system controlling the control entrance device for enabling the end-user to enter in the room, and opening of a menu of the communication control application of the end-user mobile communication device, said menu providing information selected from the group consisting of at least (a) information about the at least one asset available in the room, (b) information about consumable goods available at the at least one predetermined asset, and (c) combination thereof;
encoding by the end-user on his mobile communication device of at least the number and type of the at least one consumable good the end-user intends to consume;
sending by the end-user mobile communication device to said central system for assistance, at least the number and type of consumable goods intended to be consumed by the end-user;
sending by the computer system for assistance access information to the predetermined asset or to an asset control system, for limiting the end-user to have access to the type and numbers of the at least one consumable good intended to be consumed by the end-user at the predetermined asset.

Advantageously, in case the method is implemented for a series of rooms with a series of assets associated to consumable goods, and for a series of end-users, said method further comprising the following further steps:
computing by the computer system for assistance information about the use of the rooms, the use of the assets, as well as of the type and number of consumable goods consumed by the end-users, whereby determining automatically in function of the use of at least of one of said rooms, as well as in function of a stock of consumable goods still available,
   a) whether the at least one of said rooms requires a cleaning, whereby sending a message to a mobile communication device of a cleaning assistant for operating an appropriate cleaning of the at least one of said rooms;
   b) whether at least one of said consumable goods has to be ordered to at least one supplier, whereby automatically ordering from said at least one supplier to supply the ordered at least one of said consumable goods;
   c) whether at least one of the said assets has to be submitted to an operation selected from the group consisting of refilling, cleaning or maintaining by an appropriate assistant, whereby sending to a mobile communication device of said appropriate assistant, a message requiring the said operation to be carried for the said at least one of said assets; and
   d) when the number of the at least one of said consumable goods used at least one of said assets exceeds a predetermined level, sending a control signal to said one or more assets or to the asset control system for blocking further access to said consumable goods and/or to said at least one of said assets.

For example, the menu of the communication control application of the end-user mobile communication device further requests from the end-user to send a message to the computer system for assistance in at least one case selected among the group consisting of: (a) in case of a problem at the asset, (b) in case of a problem with consumable goods, (c) in case of problem with the room, and (d) in case of lack of problem;
whereby, after receiving a message relating to the presence of a problem, enabling the computer system for assistance to automatically send a message on the mobile communication device of an appropriate assistant requesting to correct the problem listed in the message sent by the computer system for assistance, and requesting to send to the computer system for assistance a report relating to said problem.

In case at least one asset with consumable goods is located within a room provided with a control entrance device provided with a control system in communication with the computer system for assistance and with a scannable entrance parameter, whereby the access by an end-user to said room is protected by the control access system, which, after checking the authorisation key of the end-user mobile communication device, controls the access of the end-user to said room, said method comprises advantageously the following steps:
scanning the scannable entrance parameter associated to the control entrance device by the end-user mobile communication device, and sending said scannable entrance parameter by the end-user mobile communication device to the computer system for assistance;
checking in a checking step by the computer system for assistance whether the end-user mobile communication device is listed in an identification database comprising identification parameter of a series of end-user mobile communication devices with authorisation key;
in case the said checking step confirms that the end-user mobile communication device has his identification parameter into the identification database, requiring from the end-user to encode his authorisation key and to send said authorisation key by the end-user mobile communication device to the computer system for assistance;
checking the authorisation key received from the end-user mobile communication device by the computer system for assistance, so as to determine whether said received authorisation key is associated to an authorisation to enter the room;
in case the checking step confirms that the received authorisation key from the end-user mobile communication device is associated to an authorisation to enter the room, sending by the computer system for assistance of an instruction to the control system controlling the control entrance device for enabling the end-user to enter in the room, and opening of a menu of the communication control application of the end-user mobile communication device, said menu providing information selected from the group consisting of at least (a) information about the at least one asset available in the room, (b) information about consumable goods available at the at least one predetermined asset, and (c) combination thereof;
encoding by the end-user on his mobile communication device of at least the number and type of the at least one consumable good the end-user intends to consume;
sending by the end-user mobile communication device to said central system for assistance, at least the number and type of consumable goods intended to be consumed by the end-user;
sending by the computer system for assistance access information to the predetermined asset or to an asset control system, for limiting the end-user to have access to the type and numbers of the at least one consumable good intended to be consumed by the end-user at the predetermined asset;
in which, after sending by the computer system for assistance an instruction to the control system controlling the control entrance device to the room, the communication control application of the end-user mobile communication device opens a menu listing a series of assets assumed to be present within the said room, said menu requiring from the end-user to confirm by sending by at least one signal to the computer system for assistance relating to said series of assets, said at least one signal being selected at least from the group consisting of (a) signal reporting the presence of the assets of said series, (b) signal reporting the lack of at least one asset of said series, (c) signal reporting damage of at least one asset of said series, (d) pictures of at least a part of the room, and (e) combinations thereof,
in which after receiving said at least one signal from the end-user mobile communication device, the computer system for assistance computes automatically whether at least one asset intended to be present in the room is signalled with a warning signal selected among the group consisting of a warning signal reporting the lack of at least one asset of said series, a warning signal reporting damage of at least one asset of said series, and a combination thereof, the computer system for assistance sends automatically a message on the mobile communication device of at least one assistant requiring at least an inspection report about the at least one warning signal.

Preferably, the appropriate assistant mobile communication device is loaded with a communication application for communicating with the computer system for assistance, said mobile communication device having at least a scanning element and being at least characterised by one characterising parameter,

whereby a security key is attributed to the assistant, said security key being associated to at least one characterising parameter of the assistant's mobile communication device, whereby an assistants' database is built up for containing characterising parameter of mobile communication devices of a series of assistant, and the security key allocated to each of said series of assistants,

whereby the access to the room is protected by the control system of the control entrance device,

said method comprising at least the following steps:
scanning the scannable entrance parameter associated to the control entrance device by the assistant's mobile communication device, and sending said scannable entrance parameter to the computer system for assistance;
checking in a checking step by the computer system for assistance whether the assistant's mobile communication device has its characterising parameter listed in the assistants' database;
in case the said checking step confirms that the assistant's mobile communication device has its characterising parameter into the assistants' database, requiring from the assistant to encode his security key and to send it to the computer system for assistance;
checking the security key received from the assistant mobile communication device, so as to determine whether said received security key is associated to an authorisation to enter the room;
in case the checking confirms that the received security key is associated to an authorisation to enter the room, sending by the computer system for assistance an instruction to the control system controlling the control entrance device for enabling the assistant to enter in the room, and opening of a menu of the communication control application providing information selected from the group at least consisting of information about the at least one asset available in the room, information about consumable goods available at the at least one predetermined asset, and operation information relating to operation to be carried out by the assistant in the room;
encoding by the assistant at least operation information selected from the group consisting of cleaning works, refilling consumable goods in at least one asset, repairing operation, maintenance operation, replacement operation of at least one asset, installation of a new asset in the room, and removal of at least one asset from the room;
automatic computing by the computer system for assistance, whether the at least one operation to be operated in the room matches with signals received from the assistant mobile communication device, whereby determining at least the one operation to be carried out by the assistant not matching with the received assistants' signals, whereby the computer system for assistance automatically sends a message selected from the group consisting of warning message and remainder message to mobile communication device selected from the group consisting of assistants mobile communication devices for the at least one operation still to be carried out.

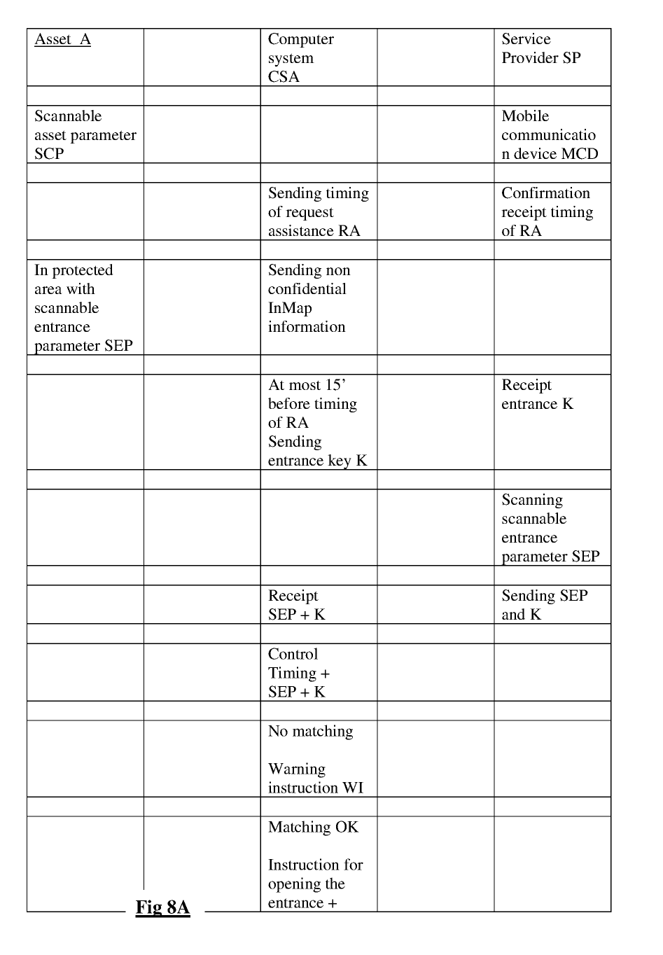

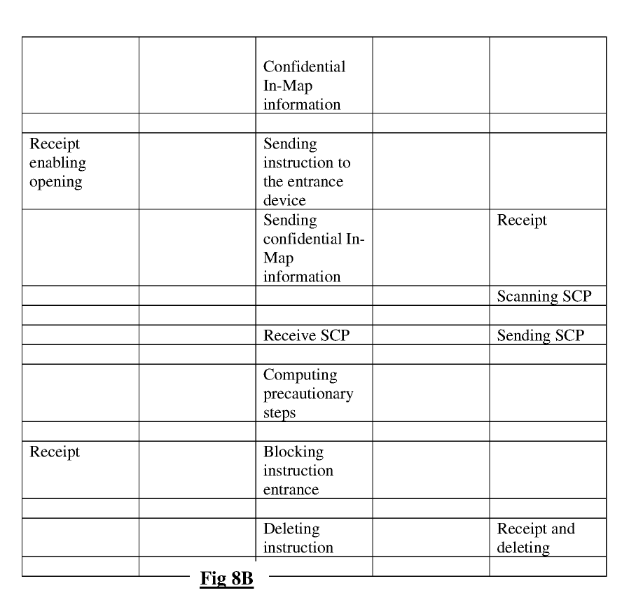

According to a specific method of the invention, which can also be implemented as steps in one or other method disclosed here above, the method is (see FIGS. 8A and 8B) a computer implemented method with a computer system CSA controlling assistance work to a predetermined asset A characterised by asset parameters including at least one scannable asset characterising parameter SCP comprising at least the asset location in a protected area of a building protected by a control entrance device associated to a scannable entrance characterising parameter SEP,
wherein the assistance of the predetermined asset A has to be carried out by an assistance provider SP having a mobile communication device MCD with at least one scanning element, said mobile communication device having a communication control application for communicating with the computer system CSA,
said method comprising at least the following steps:
sending by the computer system CSA for assistance the timing of a request of assistance work RA to the mobile communication device MCD of the assistance provider SP;
confirming by the mobile communication device MCD of the assistance provider, reception of the timing of the request of assistance work RA;
sending by the computer system to the mobile communication device of the assistance provider, a first In-Map information comprising map information of the building up to the control entrance device of the protected area, said first In-Map information not comprising precise information about location of the predetermined asset in said protected area (non confidential In-Map information);
at most 15 minutes before the timing of the request of assistance work, sending by the computer system to the mobile communication device of the assistance provider, an entrance key K;
scanning the scannable entrance characterising parameter SEP by the at least one scanning element of the mobile communication device MCD of the assistance provider SP;
sending the scannable entrance characterizing parameter SEP and the entrance key K by the mobile communication device MCD of the assistance provider to the computer system CSA;
controlling a matching of the timing of the request of assistance, the scannable entrance characterising parameter and the entrance key (Timing+SEP+K), by the computer system, whereby the computer system implements (a) at least one first entrance control instruction selected among the group consisting of opening instruction for the control entrance device adapted for enabling the opening of the control entrance device in case of matching of the timing of the request of assistance RA, the scannable entrance characterising parameter SEP and the entrance key K, and a warning instruction WI blocking the control entrance device in case of lack of matching of the timing of the request of assistance, the scannable entrance characterising parameter and the entrance key, and (b) an In-Map information enabling precise location of the predetermined asset in said protected area (confidential In Map information), in case of matching of the timing of the request of assistance, the scannable entrance characterising parameter and the entrance key;
sending to the control entrance device at least said one entrance control instruction for enabling the assistance provider to enter into the protected area in case of matching of the timing of the request of assistance, the scannable entrance characterising parameter and the entrance key, while preventing the assistance provider to enter in the protected area in case of lack of matching of the timing of the request of assistance, the scannable entrance characterising parameter and the entrance key;
sending to the mobile communication device of the assistance provider of the In-Map information enabling precise location of the predetermined asset in said protected area, in case of matching of the timing of the request of assistance, the scannable entrance characterising parameter and the entrance key;
scanning the scannable asset characterising parameter of the predetermined asset by the at least one scanning element of the mobile communication device of the assistance provider;
sending the scannable asset characterising parameter of the predetermined asset by mobile communication device of the assistance provider to the computer system; and
computing by the computer system of a precautionary instruction or step selected among the group consisting of a blocking instruction for the control entrance device after receipt of the scannable asset parameter by the computer system from the mobile communication device of the assistance provider, a blocking instruction for the control entrance device after the timing of the request of assistance work, an instruction for deleting on the mobile communication device of the service provider the In-Map information enabling precise location of the predetermined asset in said protected area after receipt of the scannable asset parameter by the computer system from the mobile communication device of the assistance provider, an instruction for deleting on the mobile communication device of the service provider the In-Map information enabling precise location of the predetermined asset in said protected area after the timing of the request of assistance work, and combinations thereof.

The latter method can comprise one or more further steps as disclosed for the other methods of the invention.

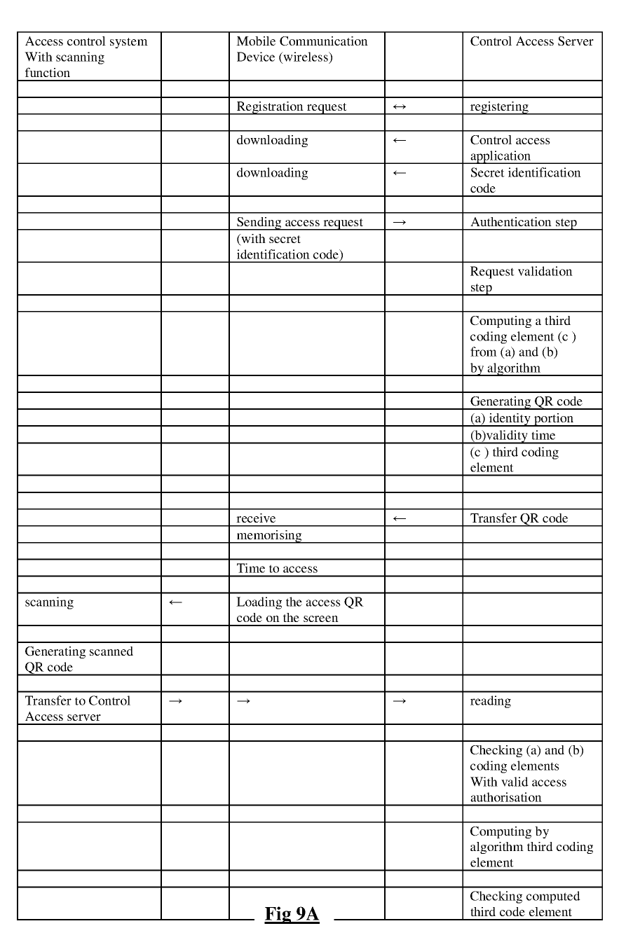

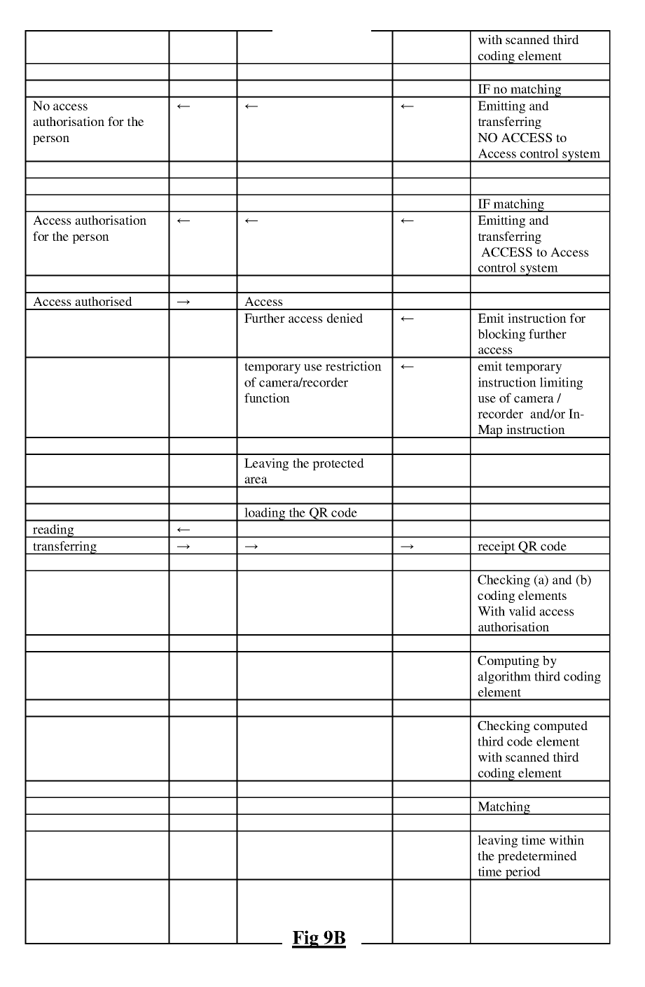

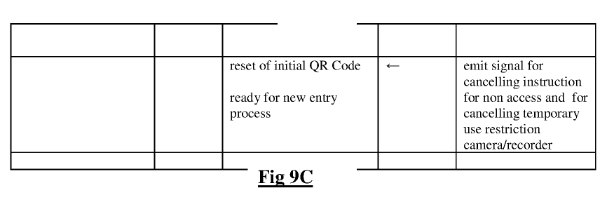

FIGS. 9A,9B,9C, 10A,10B and 11A to 11C are flow sheets of methods for securing the access of a person or a group of persons in an area (such as a room, building, stadium, concerts, air planes, etc.).

Allowing or denying access to people is more and more complicated, as some time guards are not able to request passports or identity cards from the people wanting to have access to a protected area, such as a concert field. In some countries, no identity cards exist at all. Moreover, all said check is time consuming with many possible errors.

For entering buildings, the person has first to log in a visiting book, before receiving a pass for opening a gate. Many people omit to give back the pass, whereby rendering complicate to know whether a person walking in a building is authorised or not.

The method of FIGS. 9A to 9C are aiming to solve also said problem with a method enabling quick check whether a person can enter into a protected area.

A first embodiment of the method of the invention shown in Figure is a method for securing the access of at least a person a protected area associated to an access control system, whereby the said person is provided with a mobile communication device with a wireless application enabling at least the mobile communication device to communicate with a control access server via a wireless system (phone communication system, WIFI, bluetooth, web, etc.), said mobile communication device (like a mobile phone, an iPad, etc.) being provided with a screen suitable for viewing at least a QR Code, while the access control system is associated at least to a scanning device (the scanning device can be part of a device used by a guard, or can be an automatic gate provided with a scanning system and which can be opened if the check is confirming the access authorisation) suitable for scanning at least a QR-code, as well as to a communication system for communicating with the control access server,

Whereby the said method comprises at least the following steps:
downloading step on the mobile communication device of the said person of a control access application, said downloading step requiring at least one registration step with the control access server, whereby the mobile communication device of the said person is provided with a registered control access application associated to at least a secret mobile communication device identifying code which is secret for the said person, but which is readable by the control access server through a wireless system,
sending to the access control system by the said person via the registered control access application of the mobile communication device through the wireless system, an access request to the protected area within a determined time period of access;
receiving the access request to the protected area within said determined time period of access, as well as the said secret mobile communication device identifying code or a parameter function of the said secret mobile communication device identifying code, by the control access server;
authentication the said secret mobile communication device identifying code or parameter function of the said secret mobile communication device identifying code by said control access server, so that the said control access server determines in a request validation step whether for the authenticated secret mobile communication device identifying code, the access request to the protected area within said predetermined time period of access is a validated access request for the authenticated secret mobile communication device identifying code;
after confirmation by the request validation step that the access request to the protected area within said predetermined time period is a validated access request for the authenticated secret mobile communication device identifying code, generating an access QR code by the control access server, said access QR code comprising at least (a) a first coding element enabling to identify the said person or the mobile communication device of the said person, and (b) a second coding element enabling to identify a validity time period for the QR Code;
transferring the said access QR code, by the control access server to the mobile communication device of the said person, via said wireless system;
receiving and memorising the said access QR code by the said mobile communication device;
before that the said person tries to have access to the protected area, loading the said access QR code or an amended access QR code generated by the control access application on the screen of the mobile communication device of the said person, said loaded access QR code or loaded amended access QR code comprising at least (a) the first coding element enabling to identify the said person or the mobile communication device of the said person, and (b) a second coding element enabling to identify a validity time period for the loaded access QR Code or amended access QR code;
scanning the access QR code or amended access QR code loaded on the screen of the mobile communication device of the said person by the scanning device associated to the access control system, whereby generating a scanned access QR code comprising at least the first coding element and the second coding element;
transferring the scanned access QR code by the access control system to the control access server;
reading the scanned QR code by the control access server so as to read the at least first coding element and second coding element;
checking by the control access server whether at least (a) said first coding element or a coding parameter at least function of the first coding element and (b) said second coding element are matching to a valid access authorisation to the protected area for the said person at a checking time comprised within a time period starting at most 30 minutes before the said determined time period of access and ending at most at the end of the determined time period of access;

In case of no matching to a valid access authorisation, emitting and transferring a non access signal by the control access server to the access control system, the latter when receiving the said non access signal denying access authorisation for the said person to the protected area, while in case of matching to a valid access authorisation, emitting and transferring an access signal by the control access server to the control access system, whereby authorising the said person to have access to the protected area.

Advantageously, the step of generating an access QR code by the control access server is adapted for generating a QR code comprising at least a first coding element enabling to identify the said person or the mobile communication device of the said person, a second coding element enabling to identify a validity time period for the QR Code, as well as a third coding element resulting from an algorithm operation, while in case of matching of the first coding element and the second coding element the checking step by the control access server compute from the said first coding element and second coding element a computed third coding element and determines whether the computed third coding element matches with the third coding element of the scanned QR code, whereby in case of no matching, the control access server emits and transfers to the access control system a non access signal, while in case of matching, an access signal is transmitted to the control access system.

Preferably, in case of emitting and transferring an access signal by the control access server to the control access system, the control access server sends a signal to the mobile communication device for attaching to a coding element selected from the group consisting of the first coding element and the second coding element an instruction for non access (so as to denying a further access).

Most preferably, the said instruction for non access is transferred by the central access server to the mobile communication device.

Possibly in case the person is leaving the protected area within the said predetermined time period, the method can further comprise the following steps:
Loading by the person on the screen of his mobile communication device of the QR code
Reading by the scanning device of the access control system
Transferring the scanned QR code to the control access server
Authentication of the mobile communication device by the control access server;

In case the leaving time of the person is within the predetermined time period, emitting by the central access server a signal to the mobile communication device for cancelling the instruction for non access, whereby enabling the person to restart the process for entry in the protected area.

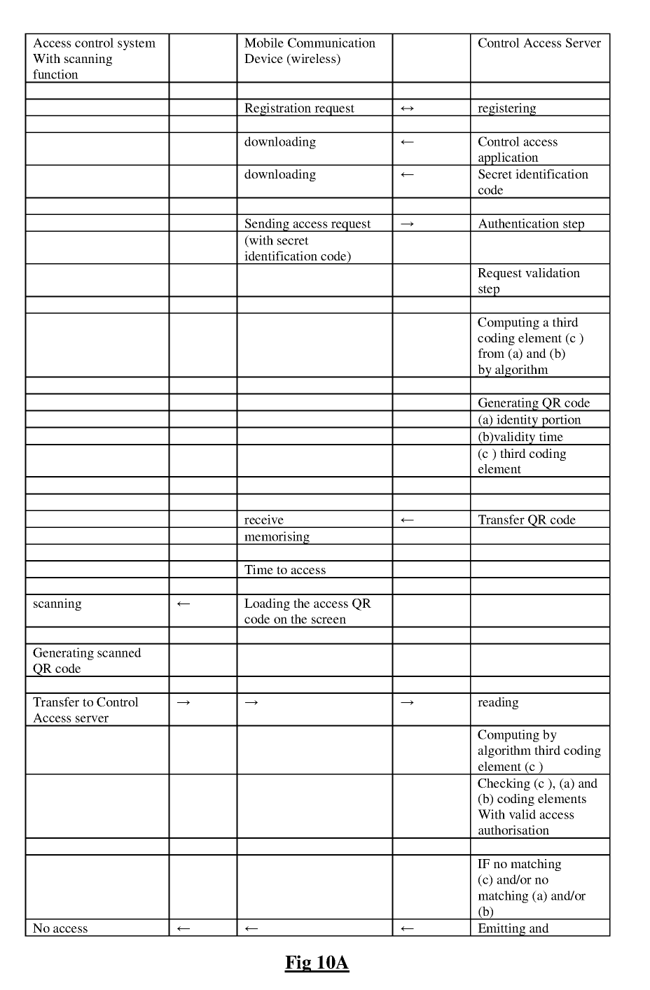

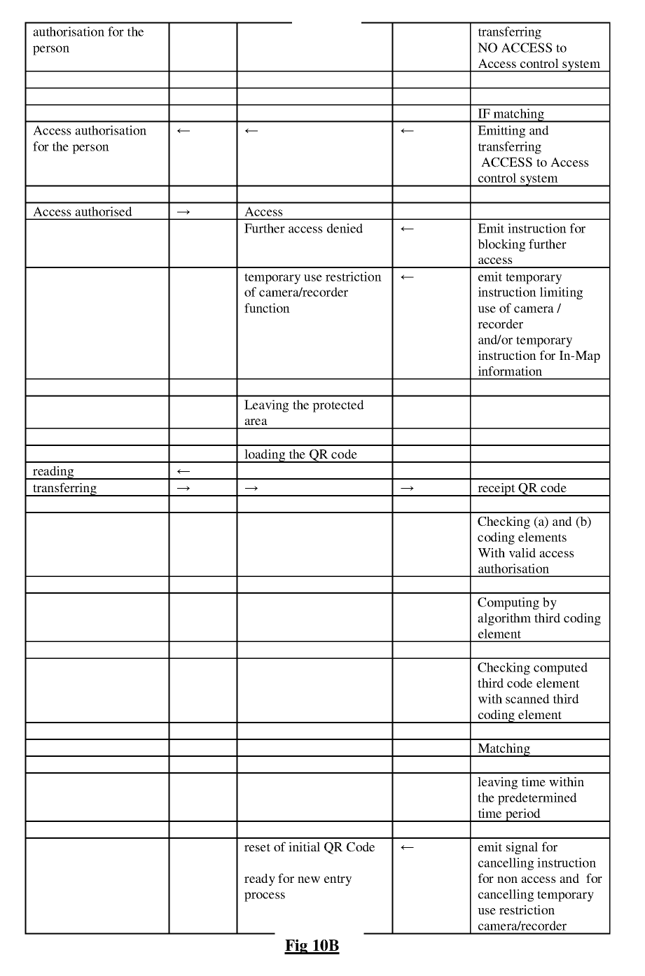

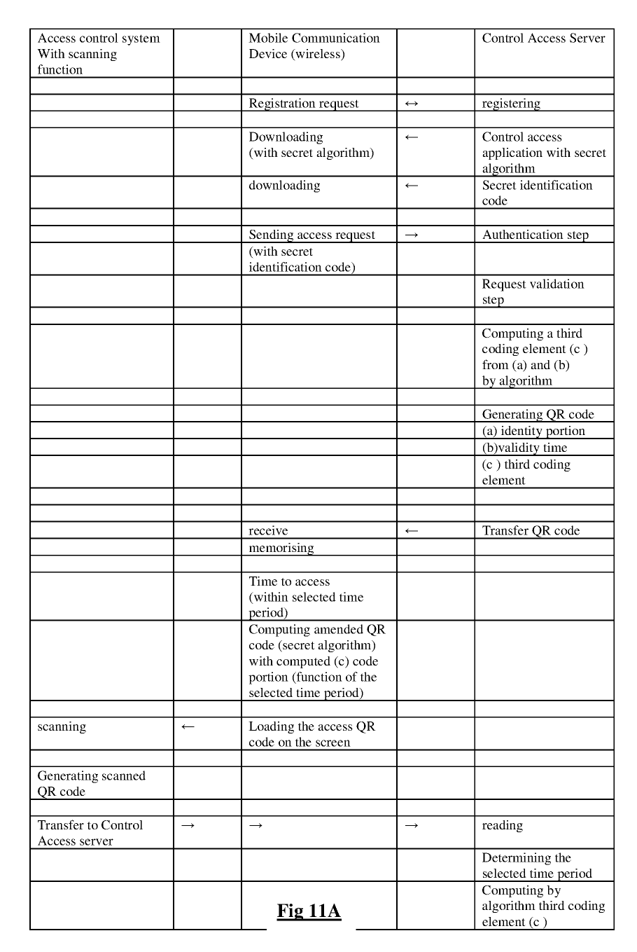

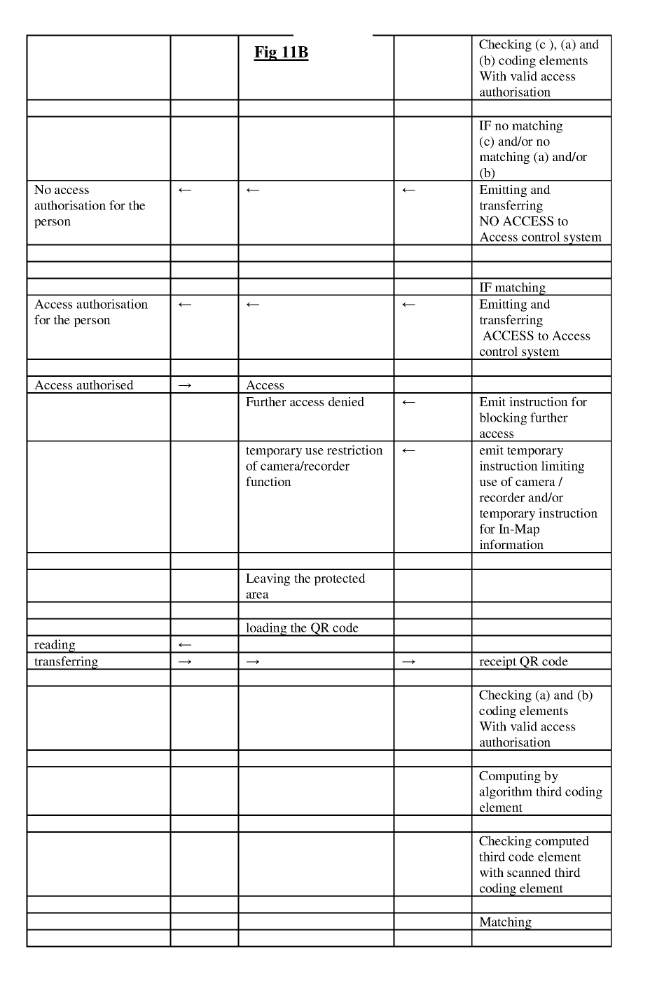

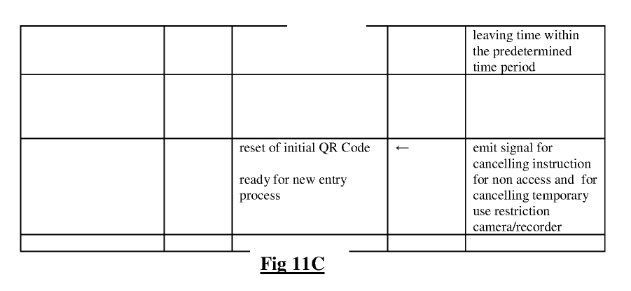

Said further steps can also be part of other methods of the invention, like the method disclosed in FIGS. 10 and 11.

In a specific embodiment, the said instruction for non access is transferred by the central access server to the mobile communication device, said instruction comprising a temporary instruction limiting the use of at least one function selected among the group consisting of camera and recorder during the determined time period of access.

Moreover, preferably, the control access server sends to the mobile communication device in-map information, advantageously temporary in-map information, about the path to follow by the person in the protected area (for example for finding his way to the seat allotted to him, the facility, etc.

Said further step can also be part of other methods of the invention, like the method disclosed in FIGS. 10 and 11.

According to a further embodiment (see FIGS. 10A and 10B), the method of the invention is a method for securing the access of a person in an area through a protected area associated to an access control system, whereby the said person is provided with a mobile communication device with a wireless application enabling at least the mobile communication device to communicate with a control access server via a wireless system, said mobile communication device being provided with a screen suitable for viewing at least a QR Code, while the access control system is associated at least to a scanning device suitable for scanning at least a QR-code, as well as to a communication system for communicating with the control access server,
Whereby the said method comprises at least the following steps:
downloading step on the mobile communication device of the said person of a control access application, said downloading step requiring at least one registration step with the control access server, whereby the mobile communication device of the said person is provided with a registered control access application associated to at least a secret mobile communication device identifying code which is secret for the said person, but which is readable by the control access server through a wireless system,
sending to the access control system by the said person via the registered control access application of the mobile communication device through the wireless system, an access request to the protected area within a determined time period of access;
receiving the access request to the protected area within said determined time period of access, as well as the said secret mobile communication device identifying code or a parameter function of the said secret mobile communication device identifying code, by the control access server;
authentication the said secret mobile communication device identifying code or parameter function of the said secret mobile communication device identifying code by said control access server, so that the said control access server determines in a request validation step whether for the authenticated secret mobile communication device identifying code, the access request to the protected area within said predetermined time period of access is a validated access request for the authenticated secret mobile communication device identifying code;
after confirmation by the request validation step that the access request to the protected area within said predetermined time period is a validated access request for the authenticated secret mobile communication device identifying code, generating an access QR code by the control access server, said access QR code comprising at least (a) a first coding element enabling to identify the said person or the mobile communication device of the said person, (b) a second coding element enabling to identify a validity time period for the QR Code and (c) a third coding element resulting from an algorithm operation at least based on a parameter function of the secret mobile communication device identifying code and on a parameter function of the validity time period;
transferring the said access QR code, by the control access server to the mobile communication device of the said person, via said wireless system;
receiving and memorising the said access QR code by the said mobile communication device;
before that the said person tries to have access to the protected area, loading the said access QR code or an amended access QR code generated by the control access application on the screen of the mobile communication device of the said person, said loaded access QR code or loaded amended access QR code comprising at least (a) the first coding element enabling to identify the said person or the mobile communication device of the said person, (b) a second coding element enabling to identify a validity time period for the loaded access QR Code or amended access QR code and (c) a third coding element generated from an algorithm operation at least based on a parameter function of the secret mobile communication device identifying code and on a parameter function of the validity time period;
scanning the access QR code or amended access QR code loaded on the screen of the mobile communication device of the said person by the scanning device associated to the access control system, whereby generating a scanned access QR code comprising at least the first coding element, the second coding element and the third coding element;
transferring the scanned access QR code by the access control system to the control access server;
reading the scanned QR code by the control access server so as to read the at least first coding element, second coding element and third coding element;
computing by the control access server a computed third coding element from at least the first coding element or parameter thereof and the second coding element or parameter thereof;
checking by the control access server whether said computed third coding element or a parameter thereof having to match with the third coding element of the scanned QR code or parameter thereof, as well as whether at least (a) said first coding element or a coding parameter at least function of the first coding element, (b) said second coding element or a parameter function of the second coding element are matching to a valid access authorisation to the protected area for the said person at a checking time comprised within a time period starting at most 30 minutes before the said determined time period of access and ending at most at the end of the determined time period of access;
whereby the control access server transfers to the access control system a non access signal for the said person at least for a non matching case selected from the group consisting of the not matching case of the computed third coding element or parameter thereof with the third coding element of the scanned QR code or parameter thereof and the not matching case of (a) said first coding element or a coding parameter at least function of the first coding element and (b) said second coding element or a parameter function of the second coding element with the said valid access authorisation, while the control access server transfers to the access control system a valid access authorisation signal in case of the matching of the computed third coding element or parameter thereof with the third coding element of the scanned QR code or parameter thereof and the matching of (a) said first coding element or a coding parameter at least function of the first coding element and (b) said second coding element or a parameter function of the second coding element with the said valid access authorisation.

Advantageously, the step of generating an access QR code by the control access server is adapted for generating a QR code comprising at least a first coding element enabling to identify the said person or the mobile communication device of the said person, a second coding element enabling to identify a validity time period for the QR Code, as well as a third coding element resulting from an algorithm operation, while in case of matching of the first coding element and the second coding element the checking step by the control access server computes from the said first coding element and second coding element a computed third coding element and determines whether the computed third coding element matches with the third coding element of the scanned QR code, whereby in case of no matching, the control access server emits and transfers to the access control system a non access signal, while in case of matching, an access signal is transmitted to the control access system.

Preferably, in case of emitting and transferring an access signal by the control access server to the control access system, the control access server attaches to a coding element selected from the group consisting of the first coding element and the second coding element an instruction for non access.

Most preferably, the said instruction for non access is transferred by the central access server to the mobile communication device.

In a specific embodiment, the said instruction for non access is transferred by the central access server to the mobile communication device, said instruction comprising a temporary instruction limiting the use of at least one function selected among the group consisting of camera and recorder during the determined time period of access.

According to a still further embodiment of the invention (see FIGS. 11A to 11C), the method is a method for securing the access of a person in an area through a protected area associated to an access control system, whereby the said person is provided with a mobile communication device with a wireless application enabling at least the mobile communication device to communicate with a control access server via a wireless system, said mobile communication device being provided with a screen suitable for viewing at least a QR Code, while the access control system is associated at least to a scanning device suitable for scanning at least a QR-code, as well as to a communication system for communicating with the control access server,

Whereby the said method comprises at least the following steps:
downloading step on the mobile communication device of the said person of a control access application, said downloading step requiring at least one registration step with the control access server, whereby the mobile communication device of the said person is provided with a registered control access application associated to at least a secret mobile communication device identifying code which is secret for the said person, but which is readable by the control access server through a wireless system, whereby the control access application is provided with an algorithm adapted to generate at a selected time period a variable portion of a QR code which is function of (a) the selected time period, (b) at least a parameter function of the secret mobile communication device identifying code and (c) at least a parameter function of the validity time period of the QR code;
sending to the access control system by the said person via the registered control access application of the mobile communication device through the wireless system, an access request to the protected area within a determined time period of access;
receiving the access request to the protected area within said determined time period of access, as well as the said secret mobile communication device identifying code or a parameter function of the said secret mobile communication device identifying code, by the control access server;
authentication the said secret mobile communication device identifying code or parameter function of the said secret mobile communication device identifying code by said control access server, so that the said control access server determines in a request validation step whether for the authenticated secret mobile communication device identifying code, the access request to the protected area within said predetermined time period of access is a validated access request for the authenticated secret mobile communication device identifying code;
after confirmation by the request validation step that the access request to the protected area within said predetermined time period is a validated access request for the authenticated secret mobile communication device identifying code, generating an access QR code by the control access server, said access QR code comprising at least (a) a first coding element enabling to identify the said person or the mobile communication device of the said person, (b) a second coding element enabling to identify a validity time period for the QR Code and (c) a coding element resulting from an algorithm operation based at least on a parameter function of the secret mobile communication device identifying code and on a parameter function of the validity time period;
transferring the said access QR code, by the control access server to the mobile communication device of the said person, via said wireless system;
receiving and memorising the said access QR code by the said mobile communication device;
before that the said person tries to have access to the protected area, computing by the mobile communication device the variable portion of a QR code which is function of (a) the selected time period, (b) at least a parameter function of the secret mobile communication device identifying code and (c) at least a parameter function of the validity time period of the QR code, and generating an access QR code;
loading the said access QR code on the screen of the mobile communication device of the said person, said loaded access QR code comprising at least (a) the first coding element enabling to identify the said person or the mobile communication device of the said person, (b) a second coding element enabling to identify a validity time period for the loaded access QR Code or amended access QR code and (c) a third coding element corresponding to said variable portion of the QR code;
scanning the access QR code loaded on the screen of the mobile communication device of the said person by the scanning device associated to the access control system, whereby generating a scanned access QR code comprising at least the first coding element, the second coding element and the third coding element;

transferring at a selected transfer timing within the selected time period, the scanned access QR code by the access control system to the control access server;
reading the scanned QR code by the control access server so as to read the at least first coding element, second coding element and third coding element, and determining the selected transfer timing the selected time period;
computing by the control access server a computed third coding element from the selected time period, the first coding element or parameter thereof and the second coding element or parameter thereof;
checking by the control access server whether said computed third coding element or a parameter thereof having to match with the third coding element of the scanned QR code or parameter thereof, as well as whether at least (a) said first coding element or a coding parameter at least function of the first coding element, (b) said second coding element or a parameter function of the second coding element are matching to a valid access authorisation to the protected area for the said person at a checking time comprised within a time period starting at most 30 minutes before the said determined time period of access and ending at most at the end of the determined time period of access;
whereby the control access server transfers to the access control system a non access signal for the said person at least for a non matching case selected from the group consisting of the not matching case of the computed third coding element or parameter thereof with the third coding element of the scanned QR code or parameter thereof and the not matching case of (a) said first coding element or a coding parameter at least function of the first coding element and (b) said second coding element or a parameter function of the second coding element with the said valid access authorisation, while the control access server transfers to the access control system a valid access authorisation signal in case of the matching of the computed third coding element or parameter thereof with the third coding element of the scanned QR code or parameter thereof and the matching of (a) said first coding element or a coding parameter at least function of the first coding element and (b) said second coding element or a parameter function of the second coding element with the said valid access authorisation.

Advantageously, the step of generating an access QR code by the control access server is adapted for generating a QR code comprising at least a first coding element enabling to identify the said person or the mobile communication device of the said person, a second coding element enabling to identify a validity time period for the QR Code, as well as a third coding element resulting from an algorithm operation, while in case of matching of the first coding element and the second coding element the checking step by the control access server computes from the said first coding element and second coding element a computed third coding element and determines whether the computed third coding element matches with the third coding element of the scanned QR code, whereby in case of no matching, the control access server emits and transfers to the access control system a non access signal, while in case of matching, an access signal is transmitted to the control access system.

Preferably, in case of emitting and transferring an access signal by the control access server to the control access system, the control access server attaches to a coding element selected from the group consisting of the first coding element and the second coding element an instruction for non access.

Most preferably, the said instruction for non access is transferred by the central access server to the mobile communication device.

In a specific embodiment, the said instruction for non access is transferred by the central access server to the mobile communication device, said instruction comprising a temporary instruction limiting the use of at least one function selected among the group consisting of camera and recorder during the determined time period of access.

1. A computer implemented method for assistance for a predetermined asset characterised by asset parameters including at least one scannable asset characterising parameter selected among the group consisting of asset type parameter, sign adapted for characterising at least the asset type and the asset location on a site or in a building, tag adapted for characterising at least the asset type and the asset location on a site or in a building, to at least a first end-user selected among a group of end-users having each a mobile communication device provided with a scanning element, whereby the said scannable asset characterising parameter is attached to the said predetermined asset, said at least first end-user mobile communication device being adapted to communicate with a computer system for assistance, said method comprising the following steps:
loading a communication control application on the mobile communication device of the said at least first end-user for secure communicating with the computer system for assistance after an authentication process with the computer system for assistance, said authentication process being operated at least partly within the mobile communication device of the said at least first end-user;
defining, for each of a group of several end-users, at least one key selected from the group consisting of security key code, password enabling communication between the mobile communication device of an end-user of said group and the computer system for assistance for the said predetermined asset, password authorising communication between the mobile communication device of an end-user of said group and the computer system for assistance for the said predetermined asset, and password limiting communication between the mobile communication device of an end-user of said group and the computer system for assistance for the said predetermined asset, whereby defining a plurality of different keys;
storing the said different keys in a keys containing database in communication with the computer system for assistance for identifying an end-user of said group, the said different keys being sent to the computer system for assistance which comprises instruction for storing the said different keys into the said keys containing database, so as to enable at least the computer system for assistance to implement a recognition function selected from the group consisting of a function to recognise a predetermined end-user using the communication control application, and a function for defining an authentication password to be sent to a predetermined end user by using the communication control application by a message;
opening by said predetermined end-user of the communication control application on the mobile communication device of the predetermined end-user, and recognising the predetermined end-user by the computer system for assistance by the key corresponding to the said predetermined end-user for enabling communication between the mobile communication device of the predetermined end-user and the computer system for assistance;
scanning a scannable characterizing parameter attached to a predetermined asset through the scanning element of the mobile communication device of the said predetermined end-user,
transmitting by the said predetermined end-user's mobile communication device, the scanned scannable characterising parameter attached to the predetermined asset, to the computer system for assistance;
computing by the computer system for assistance of the scanned scannable characterising parameter attached to the predetermined asset for registering the said predetermined asset, at least by storing the scanned scannable characterising parameter, as well as a plurality of asset working parameters of the predetermined asset, in an asset database in communication with the computer system for assistance;
opening of an assistance function of the communication control application by a predetermined end-user mobile communication device, after a logs in requiring encoding the key corresponding to the predetermined end user;
checking by the communication control application of the predetermined end-user mobile communication device, whether the predetermined end-user mobile communication device is authorised to communicate with the computer system for sending an assistance request following the scanning of a scannable characterising parameter attached to an asset,
whereby in case of authorisation of communication of the end-user mobile communication device with the computer system for assistance for the said predetermined asset, transferring the scannable characterising parameter and information about an assistance request for an assistance required for the said predetermined asset, by the end-user mobile communication device to the computer system for assistance;
computing by the computer system for assistance an assistance control step for controlling at least whether the predetermined end-user key is authorising the said computer system for treating an assistance request from the said predetermined end-user mobile communication device, and whether an assistance request for said predetermined asset corresponding to the transferred scannable characterising parameter is already handled by the computer system for assistance,
sending, following the said assistance control step, by the computer system for assistance to the predetermined end user's mobile communication device at least one message selected from the group consisting of: a message advising that the predetermined end-user is not entitled to file a request for assistance for the said predetermined asset, a message confirming the prosecution of the request of assistance for said predetermined asset sent by the said end-user, and a message signalling that a request of assistance for the said predetermined asset is already handled by the computer system for assistance, and
selecting by the computer system for assistance, at least one service provider selected from a database in communication with the computer system for assistance for managing the assistance request of the predetermined asset, and contacting the said at one selected service provider through his mobile communication device so as to provide him at least information about the predetermined asset requiring assistance, information about the requested assistance for said predetermined asset, and information about the location of the said predetermined asset in a building;
receiving from the mobile communication device of the selected service provider and from a mobile communication device of an asset dedicated person selected from the group consisting of the end-user and a person dedicated to manage the said predetermined asset in the building, a series of dates and hours convenient for assistance working to the said predetermined asset, and selecting in said series of dates and hours at least one date and hour for the assistance working convenient for both the selected service provider and the asset dedicated person, and confirming by the computer system for assistance, to said selected service provider and said asset dedicated person, the date and hours for the assistance work, as well as information associated to a path to follow by the selected service provider for reaching the predetermined asset in the building,
controlling by the computer system for assistance information about displacement of the selected service provider in the building, said computer system for assistance receiving at least the following information: information from the mobile communication device of the selected service provider relating to the date and hour when the selected service provider enters into the building or part thereof where the predetermined asset requiring assistance is located, information from the mobile communication device of the asset dedicated person confirming the asset dedicated person is present into the building or part thereof where the predetermined asset requiring assistance is located, information about the path followed by the selected service provider in the building, information about the assistance working carried out by the selected service provider, information relating to the end of the assistance working by the mobile communication device of the selected service provider, and information from the mobile communication device of the asset dedicated person confirming the end of the assistance working by the selected service provider;
editing automatically by the computer assistance system a report on the carried assistance working, said report comprising at least information about the selected service provider and information about the completion of the assistance working, and
sending automatically the said report or part thereof, by the computer system for assistance, at least to the mobile communication device of the asset dedicated person.

2. The computer implemented method of claim 1, in which the step of registering the asset further comprises the transmission of a serial number of the asset, and
in which before registering the asset, the computer system for assistance controls whether the predetermined end-user mobile communication device is authorised to communicate with the computer system for assistance for the step of registering the asset, and in the affirmative, whether an asset having the said serial number has already been registered, whereby in case the predetermined end-user mobile communication device is not authorised to register said asset, the computer system for assistance sends an error message to a mobile communication device of at least a person selected from the group consisting of the end-user and the asset dedicated person, while in case the asset is already registered in the asset database, the computer system for assistance sends an error message at least to the end-user's mobile communication device.

3. The computer implemented method of claim 1, in which the computer system for assistance is supplying to the mobile communication device of the selected service provider and to the mobile communication device of the asset dedicated person an In-map description of the path to follow in the building for reaching the asset requiring assistance.

4. The computer implemented method of the claim 3, which comprises the following further steps:
defining step by the asset dedicated person for defining and communicating through his mobile communication device to the computer system for assistance, the path to follow by the service provider to reach the predetermined asset requiring assistance, and
a remainder step whereby the computer system for assistance sends at least to the mobile communication device of the asset dedicated person and to the mobile communication device of the service provider a reminder message reconfirming the date and hour range for the assistance service.

5. The computer implemented method of the claim 1, in which the service provider has a mobile communication device with scanning function, whereby the method comprises the following further steps:
scanning by the mobile communication device of the selected service provider, the scannable asset characterising parameter of the asset requiring assistance, and sending said scannable asset characterising parameter, by said mobile communication device of the selected service provider to the computer system for assistance, before starting assistance working on the asset by the service provider,
following the receipt of said scannable asset characterising parameter from the mobile communication device of the selected provider by the computer system for assistance, automatic checking by the computer system for assistance, at least one of the points selected form the group consisting of: (a) whether the scanned scannable asset characterising parameter fits to the asset requiring assistance by the said selected service provider; (b) whether the scanned scannable asset characterising parameter fits to an asset no more requiring assistance by the said selected service provider; and (c) whether the scanned scannable asset characterising parameter fits to an asset requiring assistance at a selected time range not fitting with the date and hour previously dedicated for the assistance work;
following said automatic checking, emitting automatically by the computer system for assistance, to at least to both the mobile communication device of the selected service provider and to the mobile communication device of the asset dedicated person, a message selected from the group consisting of (a) a message confirming that the scanned scannable asset characterising parameter corresponds to the parameter of the asset requiring assistance, (b) a warning message that the scanned scannable asset characterising parameter does not fit with the asset requiring assistance, (c) a warning message that the scanned scannable parameter asset corresponds to an asset not requiring assistance at the selected time range.

6. The computer implemented method of claim 1, comprising further the steps of:
defining, after a registration step of an asset, an asset characterising parameter by the computer system for assistance for the asset to be registered;
communicating the said asset characterising parameter by the computer system for assistance, to the asset dedicated person, while requiring him to print it on a support for forming a printed asset characterising parameter;
printing the asset characterising parameter on the support, and
attaching the support with the printed asset characterising parameter by the asset dedicated person.

7. The computer implemented method of claim 1, in which the end-user has a series of end-user independent mobile communication devices provided each with a scanning element, which are each adapted for
scanning the scannable asset characterising parameter attached to a predetermined asset; and
transferring the scanned scannable asset characterising parameter of the predetermined asset, as well as information about an assistance request for an assistance required for the said asset, to the computer system for assistance;
in which the computer implemented method has the further steps:
automatic controlling by the computer system for assistance when receiving at least from one of the series of the end-user independent mobile communication devices a scannable asset characterising parameter attached to the predetermined asset, whether an assistance request for the said predetermined asset has already been transmitted to the computer system for assistance, and
transmitting automatically by the computer system for assistance to at least several end-user independent mobile communication devices of the said series, a message comprising the date and hour range for the assistance service, as well as information about the service provider for said assistance service.

8. The computer implemented method of claim 1, in which the asset requiring assistance is located in a protected area of the building, said protected area being protected by a special authorisation key authorising the access to the said protected area, said method further comprising at least the step of:
Sending by the computer system for assistance to the mobile communication device of the selected service provider the special authorization key authorizing the service provider to enter the said protected area for a date and a hour range for the assistance service, at most 15 minutes before the start of the dedicated date and hour range for the assistance service to be carried out by the said selected service provider.

9. The computer implemented method of claim 1, in which, in case the computer system for assistance receives from a mobile communication device of an asset dedicated person, a scannable asset characterising parameter of a first asset requiring assistance, the computer system for assistance checks whether a service provider suitable for assistance to the said first asset for which assistance is required has already been requested for assistance of another asset within the building, and sends to the mobile communication device of said service provider for assistance of said other asset, at least a message requiring to also carry assistance work for the said first asset at a same date.

10. The computer implemented method of claim 1, with at least one asset associated to at least one consumable good, whereby the access by a predetermined end-user to said one asset associated to said at least one consumable good is protected by a control access system, in which the method comprises the following steps:
checking by the computer system for assistance, whether the key attached to the communication control application of the end-user mobile communication device of said predetermined end-user authorises or not the said predetermined end-user to have access to said at least one consumable good associated to said asset in consideration,
after checking that the end-user's key authorises the access to said at least one consumable good from the predetermined asset, opening of a menu of the communication control application of the end-user's mobile communication device, said menu providing information about the said at least one consumable good available at the predetermined asset;
encoding by the end-user on his mobile communication device of at least one consumable good parameter selected among the group consisting of type of consumable good intended to be consumed, number of consumable good intended to be consumed, and combination thereof;
sending by the end-user mobile communication device to said computer system for assistance, at least the said at least one consumable good parameter;
sending by the computer system for assistance access information to the predetermined asset, authorising the end-user to have access to said at least one consumable good at the predetermined asset in accordance to the said at least one consumable good parameter;
computing by the computer system for assistance at least the type and number of consumable goods used by end-users for each assets with consumable goods, whereby determining automatically in function of a stock of consumable goods still available for said at least one predetermined asset,
a) whether said consumable goods have to be ordered to at least one supplier, whereby automatically ordering from said at least one supplier to supply the necessary consumable goods;
b) whether said at least one predetermined asset has to be refilled with consumable goods, whereby sending automatically a refillable message to the mobile communication device of the asset dedicated person.

11. The computer implemented method of claim 1, with at least one asset with consumable goods located within a room provided with a control entrance device provided with a control system in communication with the computer system for assistance and with a scannable entrance parameter, whereby the access by an end-user to said room is protected by the control access system, which, after checking the authorisation key of the end-user mobile communication device, controls the access of the end-user to said room, said method comprising the following steps:
scanning the scannable entrance parameter associated to the control entrance device by the end-user mobile communication device, and sending said scannable entrance parameter by the end-user mobile communication device to the computer system for assistance;
checking in a checking step by the computer system for assistance whether the end-user mobile communication device is listed in an identification database comprising identification parameter of a series of end-user mobile communication devices with authorisation key;
in case the said checking step confirms that the end-user mobile communication device has his identification parameter into the identification database, requiring from the end-user to encode his authorisation key and to send said authorisation key by the end-user mobile communication device to the computer system for assistance;
checking the authorisation key received from the end-user mobile communication device by the computer system for assistance, so as to determine whether said received authorisation key is associated to an authorisation to enter the room;
in case the checking step confirms that the received authorisation key from the end-user mobile communication device is associated to an authorisation to enter the room, sending by the computer system for assistance of an instruction to the control system controlling the control entrance device for enabling the end-user to enter in the room, and opening of a menu of the communication control application of the end-user mobile communication device, said menu providing information selected from the group consisting of at least (a) information about the at least one asset available in the room, (b) information about consumable goods available at the at least one predetermined asset, and (c) combination thereof;
encoding by the end-user on his mobile communication device of at least the number and type of the at least one consumable good the end-user intends to consume;
sending by the end-user mobile communication device to said central system for assistance, at least the number and type of consumable goods intended to be consumed by the end-user;
sending by the computer system for assistance access information to the predetermined asset or to an asset control system, for limiting the end-user to have access to the type and numbers of the at least one consumable good intended to be consumed by the end-user at the predetermined asset.

12. The computer implemented method of claim 11, implemented for a series of rooms with a series of assets associated to consumable goods, and for a series of end-users, said method further comprising the following further steps:
computing by the computer system for assistance information about the use of the rooms, the use of the assets, as well as of the type and number of consumable goods consumed by the end-users, whereby determining automatically in function of the use of at least of one of said rooms, as well as in function of a stock of consumable goods still available,
a) whether the at least one of said rooms requires a cleaning, whereby sending a message to a mobile communication device of a cleaning assistant for operating an appropriate cleaning of the at least one of said rooms;
b) whether at least one of said consumable goods has to be ordered to at least one supplier, whereby automatically ordering from said at least one supplier to supply the ordered at least one of said consumable goods;
c) whether at least one of the said assets has to be submitted to an operation selected from the group consisting of refilling, cleaning or maintaining by an appropriate assistant, whereby sending to a mobile communication device of said appropriate assistant, a message requiring the said operation to be carried for the said at least one of said assets; and
d) when the number of the at least one of said consumable goods used at least one of said assets exceeds a predetermined level, sending a control signal to said one or more assets or to the asset control system for blocking further access to said consumable goods and/or to said at least one of said assets.

13. The computer implemented method of claim 11, in which, the menu of the communication control application of the end-user mobile communication device further requests from the end-user to send a message to the computer system for assistance in at least one case selected among the group consisting of: (a) in case of a problem at the asset, (b) in case of a problem with consumable goods, (c) in case of problem with the room, and (d) in case of lack of problem;
whereby, after receiving a message relating to the presence of a problem, enabling the computer system for assistance to automatically send a message on the mobile communication device of an appropriate assistant requesting to correct the problem listed in the message sent by the computer system for assistance, and requesting to send to the computer system for assistance a report relating to said problem.

14. The computer implemented method of claim 1, with at least one asset with consumable goods located within a room provided with a control entrance device provided with a control system in communication with the computer system for assistance and with a scannable entrance parameter, whereby the access by an end-user to said room is protected by the control access system, which, after checking the authorisation key of the end-user mobile communication device, controls the access of the end-user to said room, said method comprising the following steps:
scanning the scannable entrance parameter associated to the control entrance device by the end-user mobile communication device, and sending said scannable entrance parameter by the end-user mobile communication device to the computer system for assistance;
checking in a checking step by the computer system for assistance whether the end-user mobile communication device is listed in an identification database comprising identification parameter of a series of end-user mobile communication devices with authorisation key;
in case the said checking step confirms that the end-user mobile communication device has his identification parameter into the identification database, requiring from the end-user to encode his authorisation key and to send said authorisation key by the end-user mobile communication device to the computer system for assistance;
checking the authorisation key received from the end-user mobile communication device by the computer system for assistance, so as to determine whether said received authorisation key is associated to an authorisation to enter the room;
in case the checking step confirms that the received authorisation key from the end-user mobile communication device is associated to an authorisation to enter the room, sending by the computer system for assistance of an instruction to the control system controlling the control entrance device for enabling the end-user to enter in the room, and opening of a menu of the communication control application of the end-user mobile communication device, said menu providing information selected from the group consisting of at least (a) information about the at least one asset available in the room, (b) information about consumable goods available at the at least one predetermined asset, and (c) combination thereof;
encoding by the end-user on his mobile communication device of at least the number and type of the at least one consumable good the end-user intends to consume;
sending by the end-user mobile communication device to said central system for assistance, at least the number and type of consumable goods intended to be consumed by the end-user;
sending by the computer system for assistance access information to the predetermined asset or to an asset control system, for limiting the end-user to have access to the type and numbers of the at least one consumable good intended to be consumed by the end-user at the predetermined asset;
in which, after sending by the computer system for assistance an instruction to the control system controlling the control entrance device to the room, the communication control application of the end-user mobile communication device opens a menu listing a series of assets assumed to be present within the said room, said menu requiring from the end-user to confirm by sending by at least one signal to the computer system for assistance relating to said series of assets, said at least one signal being selected at least from the group consisting of (a) signal reporting the presence of the assets of said series, (b) signal reporting the lack of at least one asset of said series, (c) signal reporting damage of at least one asset of said series, (d) pictures of at least a part of the room, and (e) combinations thereof,
in which after receiving said at least one signal from the end-user mobile communication device, the computer system for assistance computes automatically whether at least one asset intended to be present in the room is signalled with a warning signal selected among the group consisting of a warning signal reporting the lack of at least one asset of said series, a warning signal reporting damage of at least one asset of said series, and a combination thereof, the computer system for assistance sends automatically a message on the mobile communication device of at least one assistant requiring at least an inspection report about the at least one warning signal.

15. The computer implemented method of claim 12, in which the appropriate assistant mobile communication device is loaded with a communication application for communicating with the computer system for assistance, said mobile communication device having at least a scanning element and being at least characterised by one characterising parameter, whereby a security key is attributed to the assistant, said security key being associated to at least one characterising parameter of the assistant's mobile communication device, whereby an assistants' database is built up for containing characterising parameter of mobile communication devices of a series of assistant, and the security key allocated to each of said series of assistants,
whereby the access to the room is protected by the control system of the control entrance device,
said method comprising at least the following steps:
scanning the scannable entrance parameter associated to the control entrance device by the assistant's mobile communication device, and sending said scannable entrance parameter to the computer system for assistance;
checking in a checking step by the computer system for assistance whether the assistant's mobile communication device has its characterising parameter listed in the assistants' database;
in case the said checking step confirms that the assistant's mobile communication device has its characterising parameter into the assistants' database, requiring from the assistant to encode his security key and to send it to the computer system for assistance;
checking the security key received from the assistant mobile communication device, so as to determine whether said received security key is associated to an authorisation to enter the room;
in case the checking confirms that the received security key is associated to an authorisation to enter the room, sending by the computer system for assistance an instruction to the control system controlling the control entrance device for enabling the assistant to enter in the room, and opening of a menu of the communication control application providing information selected from the group at least consisting of information about the at least one asset available in the room, information about consumable goods available at the at least one predetermined asset, and operation information relating to operation to be carried out by the assistant in the room;
encoding by the assistant at least operation information selected from the group consisting of cleaning works, refilling consumable goods in at least one asset, repairing operation, maintenance operation, replacement operation of at least one asset, installation of a new asset in the room, and removal of at least one asset from the room;
automatic computing by the computer system for assistance, whether the at least one operation to be operated in the room matches with signals received from the assistant mobile communication device, whereby determining at least the one operation to be carried out by the assistant not matching with the received assistants' signals, whereby the computer system for assistance automatically sends a message selected from the group consisting of warning message and remainder message to mobile communication device selected from the group consisting of assistants mobile communication devices for the at least one operation still to be carried out.

16. A computer implemented method with a computer system controlling assistance work to a predetermined asset characterised by asset parameters including at least one scannable asset characterising parameter comprising at least the asset location in a protected area of a building protected by a control entrance device associated to a scannable entrance characterising parameter,
Wherein the assistance of the predetermined asset has to be carried out by an assistance provider having a mobile communication device with at least one scanning element, said mobile communication device having a communication control application for communicating with the computer system,
Said method comprising at least the following steps:
sending by the computer system for assistance the timing of a request of assistance work to the mobile communication device of the assistance provider;
confirming by the mobile communication device of the assistance provider, reception of the timing of the request of assistance work;
sending by the computer system to the mobile communication device of the assistance provider, a first In-Map information comprising map information of the building up to the control entrance device of the protected area, said first In-Map information not comprising precise information about location of the predetermined asset in said protected area;
at most 15 minutes before the timing of the request of assistance work, sending by the computer system to the mobile communication device of the assistance provider, an entrance key;
scanning the scannable entrance characterising parameter by the at least one scanning element of the mobile communication device of the assistance provider;
sending the scannable entrance characterizing parameter and the entrance key by the mobile communication device of the assistance provider to the computer system;
controlling a matching of the timing of the request of assistance, the scannable entrance characterising parameter and the entrance key, by the computer system, whereby the computer system implements (a) at least one first entrance control instruction selected among the group consisting of opening instruction for the control entrance device adapted for enabling the opening of the control entrance device in case of matching of the timing of the request of assistance, the scannable entrance characterising parameter and the entrance key, and a warning instruction blocking the control entrance device in case of lack of matching of the timing of the request of assistance, the scannable entrance characterising parameter and the entrance key, and (b) an In-Map information enabling precise location of the predetermined asset in said protected area, in case of matching of the timing of the request of assistance, the scannable entrance characterising parameter and the entrance key;
sending to the control entrance device at least said one entrance control instruction for enabling the assistance provider to enter into the protected area in case of matching of the timing of the request of assistance, the scannable entrance characterising parameter and the entrance key, while preventing the assistance provider to enter in the protected area in case of lack of matching of the timing of the request of assistance, the scannable entrance characterising parameter and the entrance key;
sending to the mobile communication device of the assistance provider of the In-Map information enabling precise location of the predetermined asset in said protected area, in case of matching of the timing of the request of assistance, the scannable entrance characterising parameter and the entrance key;
scanning the scannable asset characterising parameter of the predetermined asset by the at least one scanning element of the mobile communication device of the assistance provider;
sending the scannable asset characterising parameter of the predetermined asset by mobile communication device of the assistance provider to the computer system; and
computing by the computer system of a precautionary instruction selected among the group consisting of a blocking instruction for the control entrance device after receipt of the scannable asset parameter by the computer system from the mobile communication device of the assistance provider, a blocking instruction for the control entrance device after the timing of the request of assistance work, an instruction for deleting on the mobile communication device of the service provider the In-Map information enabling precise location of the predetermined asset in said protected area after receipt of the scannable asset parameter by the computer system from the mobile communication device of the assistance provider, an instruction for deleting on the mobile communication device of the service provider the In-Map information enabling precise location of the predetermined asset in said protected area after the timing of the request of assistance work, and combinations thereof.

17. A computer implemented method for securing the access of a person in an area through a protected area associated to an access control system, whereby the said person is provided with a mobile communication device with a wireless application enabling at least the mobile communication device to communicate with a control access server via a wireless system, said mobile communication device being provided with a screen suitable for viewing at least a QR Code, while the access control system is associated at least to a scanning device suitable for scanning at least a QR-code, as well as to a communication system for communicating with the control access server,
Whereby the said method comprises at least the following steps:
downloading step on the mobile communication device of the said person of a control access application, said downloading step requiring at least one registration step with the control access server, whereby the mobile communication device of the said person is provided with a registered control access application associated to at least a secret mobile communication device identifying code which is secret for the said person, but which is readable by the control access server through a wireless system,
sending to the access control system by the said person via the registered control access application of the mobile communication device through the wireless system, an access request to the protected area within a determined time period of access;
receiving the access request to the protected area within said determined time period of access, as well as the said secret mobile communication device identifying code or a parameter function of the said secret mobile communication device identifying code, by the control access server;
authentication the said secret mobile communication device identifying code or parameter function of the said secret mobile communication device identifying code by said control access server, so that the said control access server determines in a request validation step whether for the authenticated secret mobile communication device identifying code, the access request to the protected area within said predetermined time period of access is a validated access request for the authenticated secret mobile communication device identifying code;
after confirmation by the request validation step that the access request to the protected area within said predetermined time period is a validated access request for the authenticated secret mobile communication device identifying code, generating an access QR code by the control access server, said access QR code comprising at least (a) a first coding element enabling to identify the said person or the mobile communication device of the said person, and (b) a second coding element enabling to identify a validity time period for the QR Code;
transferring the said access QR code, by the control access server to the mobile communication device of the said person, via said wireless system;
receiving and memorising the said access QR code by the said mobile communication device;
before that the said person tries to have access to the protected area, loading the said access QR code or an amended access QR code generated by the control access application on the screen of the mobile communication device of the said person, said loaded access QR code or loaded amended access QR code comprising at least (a) the first coding element enabling to identify the said person or the mobile communication device of the said person, and (b) a second coding element enabling to identify a validity time period for the loaded access QR Code or amended access QR code;
scanning the access QR code or amended access QR code loaded on the screen of the mobile communication device of the said person by the scanning device associated to the access control system, whereby generating a scanned access QR code comprising at least the first coding element and the second coding element;
transferring the scanned access QR code by the access control system to the control access server;
reading the scanned QR code by the control access server so as to read the at least first coding element and second coding element;
checking by the control access server whether at least (a) said first coding element or a coding parameter at least function of the first coding element and (b) said second coding element are matching to a valid access authorisation to the protected area for the said person at a checking time comprised within a time period starting at most 30 minutes before the said determined time period of access and ending at most at the end of the determined time period of access;
In case of no matching to a valid access authorisation, emitting and transferring a non access signal by the control access server to the access control system, the latter when receiving the said non access signal denying access authorisation for the said person to the protected area, while in case of matching to a valid access authorisation, emitting and transferring an access signal by the control access server to the control access system, whereby authorising the said person to have access to the protected area.

18. The method of claim 17, whereby said method comprises at least the following steps:
downloading step on the mobile communication device of the said person of a control access application, said downloading step requiring at least one registration step with the control access server, whereby the mobile communication device of the said person is provided with a registered control access application associated to at least a secret mobile communication device identifying code which is secret for the said person, but which is readable by the control access server through a wireless system,
sending to the access control system by the said person via the registered control access application of the mobile communication device through the wireless system, an access request to the protected area within a determined time period of access;
receiving the access request to the protected area within said determined time period of access, as well as the said secret mobile communication device identifying code or a parameter function of the said secret mobile communication device identifying code, by the control access server;
authentication the said secret mobile communication device identifying code or parameter function of the said secret mobile communication device identifying code by said control access server, so that the said control access server determines in a request validation step whether for the authenticated secret mobile communication device identifying code, the access request to the protected area within said predetermined time period of access is a validated access request for the authenticated secret mobile communication device identifying code;
after confirmation by the request validation step that the access request to the protected area within said predetermined time period is a validated access request for the authenticated secret mobile communication device identifying code, generating an access QR code by the control access server, said access QR code comprising at least (a) a first coding element enabling to identify the said person or the mobile communication device of the said person, (b) a second coding element enabling to identify a validity time period for the QR Code and (c) a third coding element resulting from an algorithm operation at least based on a parameter function of the secret mobile communication device identifying code and on a parameter function of the validity time period;
transferring the said access QR code, by the control access server to the mobile communication device of the said person, via said wireless system;
receiving and memorising the said access QR code by the said mobile communication device;
before that the said person tries to have access to the protected area, loading the said access QR code or an amended access QR code generated by the control access application on the screen of the mobile communication device of the said person, said loaded access QR code or loaded amended access QR code comprising at least (a) the first coding element enabling to identify the said person or the mobile communication device of the said person, (b) a second coding element enabling to identify a validity time period for the loaded access QR Code or amended access QR code and (c) a third coding element generated from an algorithm operation at least based on a parameter function of the secret mobile communication device identifying code and on a parameter function of the validity time period;
scanning the access QR code or amended access QR code loaded on the screen of the mobile communication device of the said person by the scanning device associated to the access control system, whereby generating a scanned access QR code comprising at least the first coding element, the second coding element and the third coding element;
transferring the scanned access QR code by the access control system to the control access server;
reading the scanned QR code by the control access server so as to read the at least first coding element, second coding element and third coding element;
computing by the control access server a computed third coding element from at least the first coding element or parameter thereof and the second coding element or parameter thereof;
checking by the control access server whether said computed third coding element or a parameter thereof having to match with the third coding element of the scanned QR code or parameter thereof, as well as whether at least (a) said first coding element or a coding parameter at least function of the first coding element, (b) said second coding element or a parameter function of the second coding element are matching to a valid access authorisation to the protected area for the said person at a checking time comprised within a time period starting at most 30 minutes before the said determined time period of access and ending at most at the end of the determined time period of access;
whereby the control access server transfers to the access control system a non access signal for the said person at least for a non matching case selected from the group consisting of the not matching case of the computed third coding element or parameter thereof with the third coding element of the scanned QR code or parameter thereof and the not matching case of (a) said first coding element or a coding parameter at least function of the first coding element and (b) said second coding element or a parameter function of the second coding element with the said valid access authorisation, while the control access server transfers to the access control system a valid access authorisation signal in case of the matching of the computed third coding element or parameter thereof with the third coding element of the scanned QR code or parameter thereof and the matching of (a) said first coding element or a coding parameter at least function of the first coding element and (b) said second coding element or a parameter function of the second coding element with the said valid access authorisation.

19. The method of claim 17, whereby the said method comprises at least the following steps:
downloading step on the mobile communication device of the said person of a control access application, said downloading step requiring at least one registration step with the control access server, whereby the mobile communication device of the said person is provided with a registered control access application associated to at least a secret mobile communication device identifying code which is secret for the said person, but which is readable by the control access server through a wireless system, whereby the control access application is provided with an algorithm adapted to generate at a selected time period a variable portion of a QR code which is function of (a) the selected time period, (b) at least a parameter function of the secret mobile communication device identifying code and (c) at least a parameter function of the validity time period of the QR code;
sending to the access control system by the said person via the registered control access application of the mobile communication device through the wireless system, an access request to the protected area within a determined time period of access;
receiving the access request to the protected area within said determined time period of access, as well as the said secret mobile communication device identifying code or a parameter function of the said secret mobile communication device identifying code, by the control access server;
authentication the said secret mobile communication device identifying code or parameter function of the said secret mobile communication device identifying code by said control access server, so that the said control access server determines in a request validation step whether for the authenticated secret mobile communication device identifying code, the access request to the protected area within said predetermined time period of access is a validated access request for the authenticated secret mobile communication device identifying code;
after confirmation by the request validation step that the access request to the protected area within said predetermined time period is a validated access request for the authenticated secret mobile communication device identifying code, generating an access QR code by the control access server, said access QR code comprising at least (a) a first coding element enabling to identify the said person or the mobile communication device of the said person, (b) a second coding element enabling to identify a validity time period for the QR Code and (c) a coding element resulting from an algorithm operation based at least on a parameter function of the secret mobile communication device identifying code and on a parameter function of the validity time period;
transferring the said access QR code, by the control access server to the mobile communication device of the said person, via said wireless system;
receiving and memorising the said access QR code by the said mobile communication device;
before that the said person tries to have access to the protected area, computing by the mobile communication device the variable portion of a QR code which is function of (a) the selected time period, (b) at least a parameter function of the secret mobile communication device identifying code and (c) at least a parameter function of the validity time period of the QR code, and generating an access QR code;
loading the said access QR code on the screen of the mobile communication device of the said person, said loaded access QR code comprising at least (a) the first coding element enabling to identify the said person or the mobile communication device of the said person, (b) a second coding element enabling to identify a validity time period for the loaded access QR Code or amended access QR code and (c) a third coding element corresponding to said variable portion of the QR code;
scanning the access QR code loaded on the screen of the mobile communication device of the said person by the scanning device associated to the access control system, whereby generating a scanned access QR code comprising at least the first coding element, the second coding element and the third coding element;
transferring at a selected transfer timing within the selected time period, the scanned access QR code by the access control system to the control access server;
reading the scanned QR code by the control access server so as to read the at least first coding element, second coding element and third coding element, and determining the selected transfer timing the selected time period;
computing by the control access server a computed third coding element from the selected time period, the first coding element or parameter thereof and the second coding element or parameter thereof;
checking by the control access server whether said computed third coding element or a parameter thereof having to match with the third coding element of the scanned QR code or parameter thereof, as well as whether at least (a) said first coding element or a coding parameter at least function of the first coding element, (b) said second coding element or a parameter function of the second coding element are matching to a valid access authorisation to the protected area for the said person at a checking time comprised within a time period starting at most 30 minutes before the said determined time period of access and ending at most at the end of the determined time period of access;
whereby the control access server transfers to the access control system a non access signal for the said person at least for a non matching case selected from the group consisting of the not matching case of the computed third coding element or parameter thereof with the third coding element of the scanned QR code or parameter thereof and the not matching case of (a) said first coding element or a coding parameter at least function of the first coding element and (b) said second coding element or a parameter function of the second coding element with the said valid access authorisation, while the control access server transfers to the access control system a valid access authorisation signal in case of the matching of the computed third coding element or parameter thereof with the third coding element of the scanned QR code or parameter thereof and the matching of (a) said first coding element or a coding parameter at least function of the first coding element and (b) said second coding element or a parameter function of the second coding element with the said valid access authorisation.

20. The method of claim 17, in which in case of emitting and transferring an access signal by the control access server to the control access system, the control access server attaches to a coding element selected from the group consisting of the first coding element and the second coding element an instruction for non access.

21. The method of claim 17, in which the said instruction for non access is transferred by the central access server to the mobile communication device.

22. The method of claim 21, in which the said instruction for non access is transferred by the central access server to the mobile communication device, said instruction comprising an temporary instruction selected among the group consisting temporary instruction limiting the use of at least one function selected among the group consisting of camera and recorder during the determined time period of access, and temporary instruction forwarding In-Map information of the protected area.
